(19) United States
(12) Patent Application Publication
(10) Pub. No.: US 2019/0327129 A1
(43) Pub. Date: Oct. 24, 2019

(54) CONNECTION CONTROL METHOD AND CONNECTION CONTROL APPARATUS

(71) Applicant: FUJITSU LIMITED, Kawasaki-shi (JP)

(72) Inventors: Masahiro Higuchi, Kobe (JP); Toshiro Ono, Nishinomiya (JP); Kazuhiro Taniguchi, Kawasaki (JP)

(73) Assignee: FUJITSU LIMITED, Kawasaki-shi (JP)

(21) Appl. No.: 16/368,164

(22) Filed: Mar. 28, 2019

(30) Foreign Application Priority Data
Apr. 24, 2018 (JP) 2018-082708

(51) Int. Cl. H04L 12/24; H04L 29/08

(52) U.S. Cl. CPC H04L 41/0672; H04L 67/1095; H04L 41/0681; H04L 41/0668

(57) ABSTRACT

A connection control apparatus includes a memory and a processor coupled to the memory. The processor is configured to identify, upon detecting a change of a state of one or more servers included in a server group, a server in a synchronous standby state with respect to a primary server after the detection of the change from servers included in the server group after the detection of the change. The processor is configured to request, upon receiving an access request from a terminal, the terminal to connect to the identified server.

### CROSS-REFERENCE TO RELATED APPLICATION

This application is based upon and claims the benefit of priority of the prior Japanese Patent Application No. 2018-082708, filed on Apr. 24, 2018, the entire contents of which are incorporated herein by reference.

### FIELD

The embodiment discussed herein is related to a connection control method and a connection control apparatus.

### BACKGROUND

In a cluster system which constitutes a multiplexing environment with multiple nodes such as, for example, multiple database (DB) servers, a multi-synchronization standby function may be used in order to improve the availability suitable for the number of nodes constituting the cluster system.

The multi-synchronization standby function is a technique in which, in a log shipping multiplexing environment provided with a primary server and one or more standby servers, the constitution of the cluster is degenerated so as to implement a continuation of a task in the primary server when an abnormality occurs in a node. For example, failover or fallback is known as a technique adopted in the multi-synchronization standby function.

The failover is a technique in which, when the primary server is failed, a number of standby servers are switched to primary servers so as to continue the task in the new primary servers. In the failover, the switch from standby servers to primary servers is performed each time the primary server is failed, until active standby servers no longer exist.

In addition, “switching” a standby server to a primary server may indicate changing (controlling) the function of a node that operates as a standby server to operate as a primary server.

The fallback is a technique in which, when a standby server is failed, the failed standby server is degenerated so as to guarantee the redundancy of DB with the remaining standby servers.

When a task for updating the DB of the cluster system is performed from a terminal, the primary server updates the DB of the primary server, and simultaneously, performs a synchronization process for reflecting the corresponding update in DBs of standby servers, in an update transaction. The update transaction is completed at the time when the log shipping to the standby servers in the synchronization process is guaranteed for the data integrity after the failover.

Since the synchronization of data is guaranteed between the standby servers to which the log shipping is guaranteed (hereinafter, referred to as “synchronous standby servers”) and the primary server, the synchronous standby servers become, for example, candidates for destinations of reference of the synchronous data by a terminal or server switch destination candidates at the time of the failover. The availability of the cluster system, for example, the availability against, for example, a new failure during the failover (simultaneous failure) is improved in proportion to the number of synchronous standby servers.

Related techniques are disclosed in, for example, Japanese Laid-open Patent Publication No. 2004-206562 and Japanese Laid-open Patent Publication No. 2009-122873.

When the number of synchronous standby servers increases, the process load of the primary server increases due to the increase in the targets of the synchronization process, and as a result, the update performance of the DB may be deteriorated.

In order to avoid the deterioration of the update performance of the DB, it may be conceived to restrict the number of synchronous standby servers in the cluster system. For example, asynchronous standby servers may be provided as standby servers of the synchronous standby servers. In the update transaction, the primary server does not guarantee the log shipping to the asynchronous standby servers (does not guarantee the data synchronization). Thus, in the synchronization process between the primary server and the asynchronous standby servers, the increase in the process load of the primary server is suppressed.

For example, the asynchronous standby servers may be used for standing by in preparation for a new failure which occurs in another server during a recovery of a server in which a failure has occurred, so as to maintain the availability.

The synchronization modes of the standby servers are managed by a database management system (DBMS) of the cluster system. For example, the DBMS may switch the synchronization modes of servers between the synchronous standby and the asynchronous standby, when the failover or fallback is performed according to a server failure.

However, when the reference task for referring to the synchronous data is performed on the DB of the cluster system from a terminal, for example, an application (AP) which operates on an application (AP) server accesses a synchronous standby server.

However, as described above, since the DBMS manages the synchronization modes of the servers, the AP server may not follow the switch of the synchronization modes of the servers by the DBMS. That is, the terminal may have difficulty in accessing an appropriate synchronous standby server in a reference task for referring to the synchronous data.

### SUMMARY

According to an aspect of the present invention, provided is a connection control apparatus including a memory and a processor coupled to the memory. The processor is configured to identify, upon detecting a change of a state of one or more servers included in a server group, a server in a synchronous standby state with respect to a primary server after the detection of the change from servers included in the server group after the detection of the change. The processor is configured to request, upon receiving an access request from a terminal, the terminal to connect to the identified server.

The object and advantages of the disclosure will be realized and attained by means of the elements and combinations particularly pointed out in the claims. It is to be understood that both the foregoing general description and the following detailed description are exemplary and explanatory and are not restrictive of the disclosure, as claimed.

### BRIEF DESCRIPTION OF DRAWINGS

FIG. 1 is a view illustrating an example of an operation of a cluster system according to a comparative example;

FIG. 2 is a view illustrating an example of an operation of a cluster system according to a comparative example;

FIG. 3 is a block diagram illustrating an example of a configuration of a cluster system according to an embodiment;

FIG. 4 is a block diagram illustrating an example of a functional configuration of a cluster system according to an embodiment;

FIG. 5 is a block diagram illustrating an example of a functional configuration of a DB server according to an embodiment;

FIG. 6A is a view illustrating an example of node information, and FIG. 6B is a view illustrating an example of a node list;

FIG. 7 is a view illustrating an example of a DB instance state transition according to an embodiment;

FIG. 8 is a view illustrating an example of performance information;

FIG. 9 is a view illustrating an example of accumulation information;

FIG. 10 is a view illustrating an example of a process according to a server state transition;

FIG. 11 is a block diagram illustrating an example of a functional configuration of an AP server according to an embodiment;

FIG. 12 is a view illustrating an example of connection candidate information;

FIG. 13 is a flowchart illustrating an example of an operation of a synchronization mode switching process by a DB server according to an embodiment;

FIG. 14 is a view illustrating an example of an operation of a cluster system according to an embodiment;

FIG. 15 is a flowchart illustrating an example of an operation of a failover process by a cluster controller of the DB server according to an embodiment;

FIG. 16 is a flowchart illustrating an example of an operation of a fallback process by the cluster controller of the DB server according to an embodiment;

FIG. 17 is a flowchart illustrating an example of an operation of a server starting-up process by the cluster controller of the DB server according to an embodiment;

FIG. 18 is a flowchart illustrating an example of an operation of a linking process by a linkage controller of the DB server according to an embodiment;

FIG. 19 is a flowchart illustrating an example of an operation of a connection destination switching process by the cluster controller of the DB server according to an embodiment;

FIG. 20 is a flowchart illustrating an example of an operation of a connection destination distributing process by the cluster controller of the DB server according to an embodiment; and

FIG. 21 is a block diagram illustrating an example of a hardware configuration of a computer according to an embodiment.

### DESCRIPTION OF EMBODIMENT

Hereinafter, an embodiment of the present disclosure will be described with reference to the accompanying drawings. However, the embodiment described below is merely exemplary, and is not intended to exclude various modifications or technical applications which are not described herein. For example, the embodiment of the present disclosure may be variously modified and performed within a scope that does not depart from the gist of the present disclosure. Further, in the drawings referred to in the embodiment, portions denoted by an identical reference numeral indicate identical or similar portions unless specified otherwise.

### <1> Embodiment

### <1-1> Comparative Example

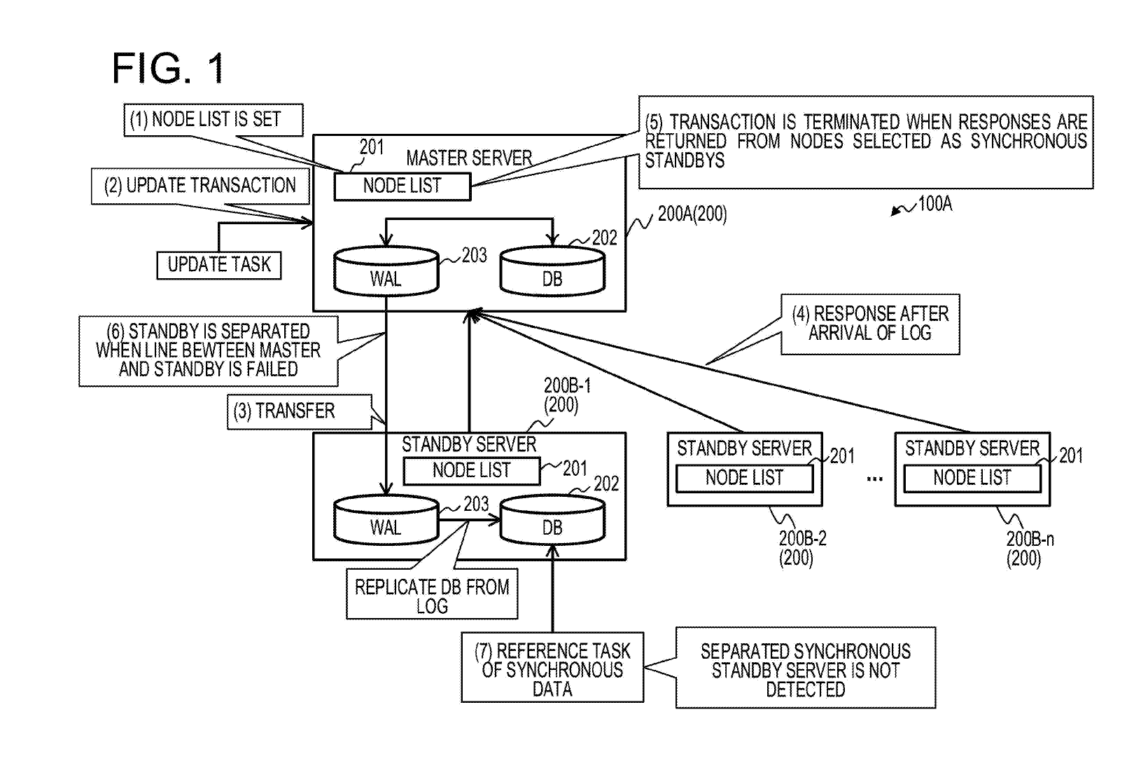

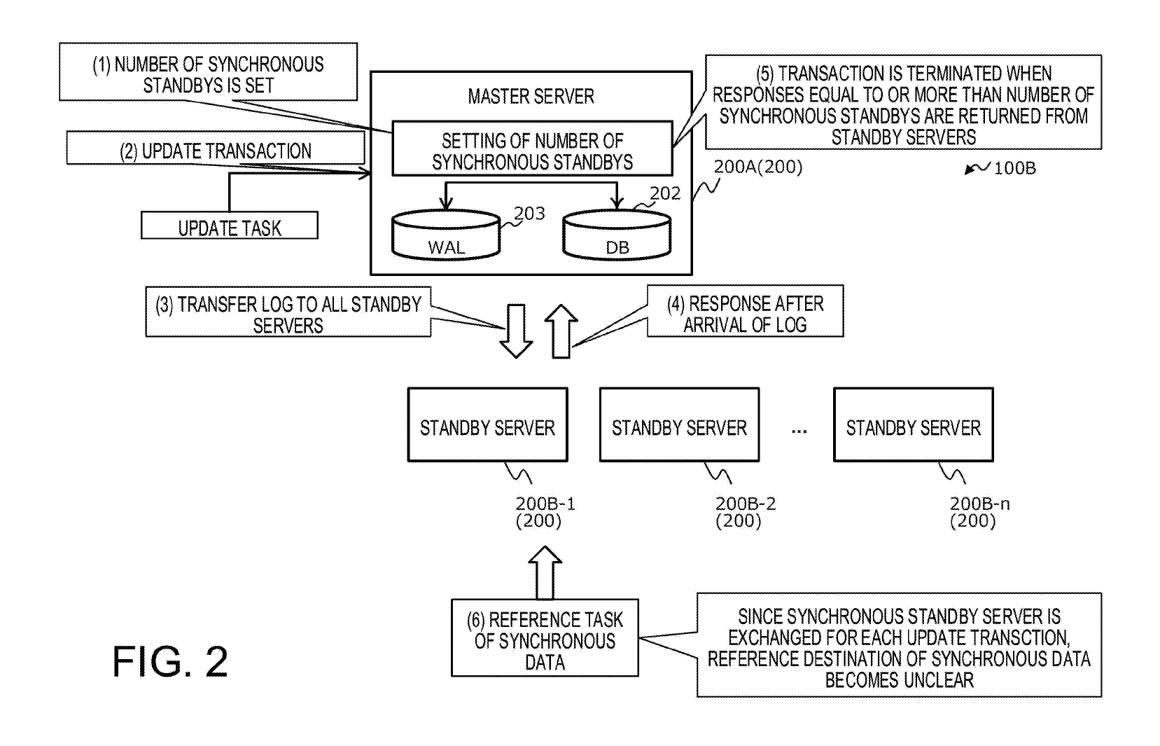

A comparative example of an embodiment will be described first with reference to FIGS. 1 and 2. FIG. 1 illustrates an example of an operation of a cluster system 100A according to a comparative example, and FIG. 2 illustrates an example of an operation of a cluster system 100B according to a comparative example.

In addition, the cluster system 100A illustrated in FIG. 1 manages synchronous standby servers using a node list 201, and the cluster system 100B illustrated in FIG. 2 manages synchronous standby servers using a quorum technique.

First, descriptions will be made on an example of an operation in a case where a synchronous standby server is separated in the cluster system 100A as illustrated in FIG. 1.

The node list 201 is set and stored in each of a master server 200A which is an example of a primary server and standby servers 200B-1 to 200B-n (n: integer of 2 or more) (see the numeral (1)).

In addition, hereinafter, the standby servers 200B-1 to 200B-n will be simply referred to as standby servers 200B when the standby servers 200B-1 to 200B-n are not discriminated from each other, and the master server 200A and the standby servers 200B will be simply referred to as servers 200 when the master server 200A and the standby servers 200B are not discriminated from each other.

The node list 201 is, for example, a list obtained by sorting the standby servers 200B in an increasing order of the log transfer latency. A system administrator may analyze the daily log transfer latency for each standby server 200B so as to generate the node list 201, and set the generated node list 201 in each server 200. The DBMS of the master server 200A selects, for example, a predetermined number of standby servers 200B with the short log transfer latency as synchronous standby servers, based on the node list 201.

In the example of FIG. 1, when an update task is generated by, for example, a terminal, the master server 200A executes the update transaction (see the numeral (2)). In the update transaction, the master server 200A performs an update process on a DB 202, and simultaneously, a synchronization process on the standby servers 200B.

For example, in the synchronization process, the master server 200A transfers (e.g., broadcasts) update result information on the update process (e.g., an update log such as WAL 203) to each of the standby servers 200B (see the numeral (3)).

The “WAL” stands for write ahead logging, and is a transaction log which is written prior to the write to the DB 202. Hereinafter, descriptions will be made assuming that the synchronization process is performed using the WAL.

When the WAL 203 is received from the master server 200A, each standby server 200B transmits a response indicating that the transfer of the update log has been completed (a log transfer completion response) to the master server 200A (see the numeral (4)). Further, each standby server 200B updates its own DB 202 based on the received WAL 203, so as to replicate the DB 202 of the master server 200A.

When the responses are received from all of the predetermined number of standby servers 200B selected as synchronous standby servers based on the node list 201, the master server 200A terminates the update transaction (see the numeral (5)).

The master server 200A and the standby servers 200B repeat the processes of the numerals (2) to (5) by the DBMS each time the update task occurs. In addition, in the synchronous standby servers among the standby servers 200B, the reference task of the synchronous data may be generated from, for example, a terminal in parallel with (asynchronously) the update task (see the numeral (7)).

Here, when, for example, a line failure occurs between the master server 200A and the standby server 200B-1, the master server 200A separates the standby server 200B-1 by the DBMS according to the fallback (see the numeral (6)).

When the separation of the standby server 200B-1 is performed during the execution of any of the processes (2) to (5) and (7), the separation may not be detected in the reference task of the synchronous data in the numeral (7). In this case, in the reference task, past data which is not synchronized with the master server 200A is referred to from the DB 202 of the standby server 200B-1.

Next, descriptions will be made on an example of an operation in a case where a synchronous standby server is separated in the cluster system 100B as illustrated in FIG. 2.

Unlike the cluster system 100A in which the node list 201 is set in each server 200, the cluster system 100B allows the system administrator to set the number of synchronous standby servers for the master server 200A (see the numeral (1)).

The processes of the reference numerals (2) to (4) are the same as those in the description of FIG. 1. In the numeral (5), the master server 200A terminates the update transaction by the DBMS when responses equal to or more than the set number of synchronous standby servers are received from the standby servers 200B. In other words, in the cluster system 100B, the synchronous standby servers are determined from the standby servers 200B in an order of the arrival of a response for each update transaction.

In this way, in the cluster system 100B, the synchronous standby servers change according to each update transaction. Thus, when the reference task of the synchronous data occurs (see the numeral (6)), the synchronous standby servers which are the reference destinations of the synchronous data become unclear.

As described above, in the examples illustrated in FIGS. 1 and 2, the DBMS takes the role of selecting the synchronous standby servers for the purpose of the stable operation of the update task in the master server 200A. Accordingly, it may not be possible to perform a linkage with the reference task which is executed through an AP server (not illustrated). Thus, when the states of the synchronous standby servers change, the change may not be detected from the reference task of the synchronous data, and past data may be referred to.

Accordingly, in an embodiment to be described hereinbelow, a method of accurately accessing a server in a state of being synchronized with a master server will be described.

<1-2> Example of Configuration of Cluster System

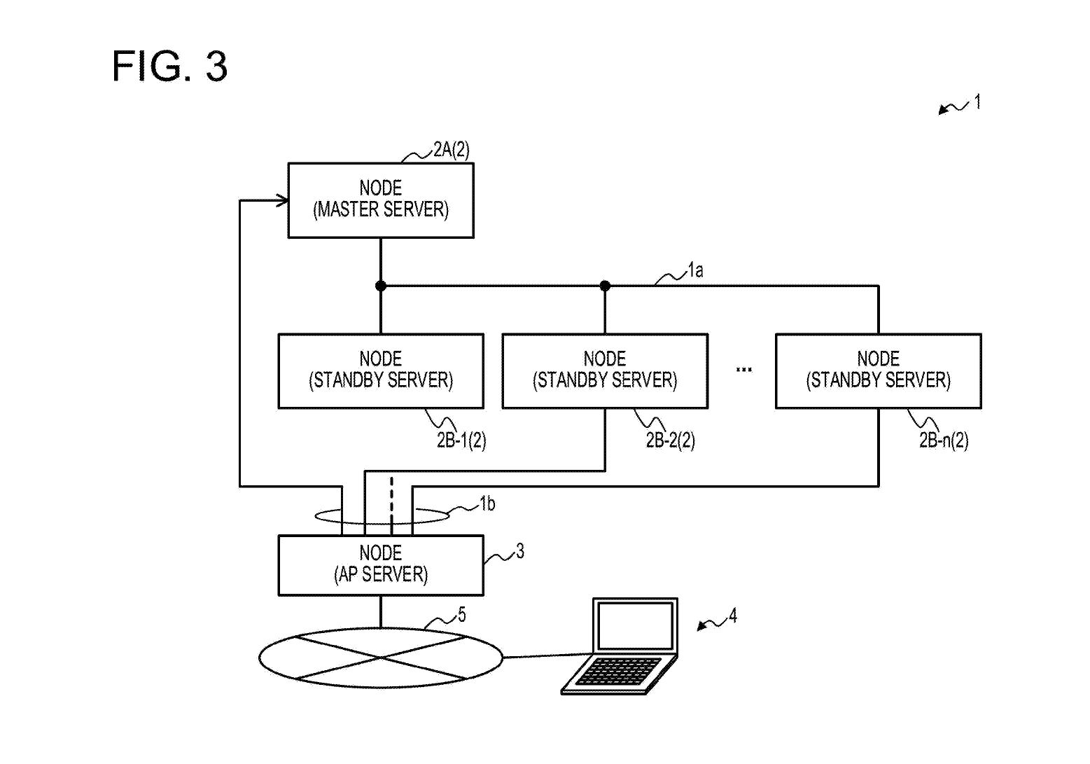

FIG. 3 is a block diagram illustrating an example of a configuration of a cluster system 1 according to an embodiment of the present disclosure. The cluster system 1 is an example of a connection control apparatus that controls a server to which a terminal performs a connection, and includes, for example, a node 2A and multiple (n in the example of FIG. 3) nodes 2B-1 to 2B-n, and one or more nodes 3 (one in the example of FIG. 3).

Hereinafter, when the nodes 2B-1 to 2B-n are not discriminated from each other, the nodes 2B-1 to 2B-n will be simply referred to as nodes 2B. Further, when the nodes 2A and 2B are not discriminated from each other, the nodes 2A and 2B will be referred to as nodes 2, servers 2 or DB servers 2.

Each of the multiple (n+1 in the example of FIG. 3) nodes 2 is a DB server in which software such as the DBMS is installed so the multi-synchronization standby function is usable. In the cluster system 1, a DB multiplexing environment may be implemented by the DBMSs executed in the multiple nodes 2.

The multiple nodes 2 may be connected to each other to be able to communicate with each other by an interconnector, for example, a network 1a such as a local area network (LAN).

Each node 2 may be variably assigned with a function (role) of any one kind of server among a “master server,” a “synchronous standby server,” and an “asynchronous standby server,” to operate as the assigned kind of server.

In the example of FIG. 3, it is assumed that one node 2A operates as a master server, and “n” nodes 2B-1 to 2B-n operate as standby servers including synchronous standby servers and asynchronous standby servers.

The master server 2A is an example of an active node (primary server) that manages the master data of the DB. When the DB update task occurs, the master server 2A executes the update transaction. In the update transaction, the master server 2A performs the update process of the DB of the master server 2A, and simultaneously, performs the synchronization process on the standby servers 2B.

The multiple standby servers 2B are an example of a server group including synchronous standby servers which are connection destinations of a terminal 4, in the reference task of the synchronous data of the DB.

Among the standby servers 2B, the synchronous standby servers are a standby node group which is a fallback of the active node, and are an example of servers which become the synchronous standby state with the master server 2A when the data of the master server 2A is synchronously backed up.

Among the standby servers 2B, the asynchronous standby servers are an asynchronous standby node group which is a fallback of the standby node group, and are an example of servers which become the asynchronous standby state with the master server 2A when the data of the master server 2A is asynchronously backed up.

In addition, in the reference task, the standby servers 2B may read at least a part of user data from the DB based on a reference instruction from the terminal 4, and may return the read data to the terminal 4 in response.

In addition, the reference task of the synchronous data to the master server 2A may be permitted according to an operation setting of the cluster system 1. In this case, the processes related to the reference task may be performed in the master server 2A as in the standby servers 2B.

The reference task of the DB may include a “reference task of synchronous data” in which real-time data is expected by taking the data synchronization with the DB of the master server 2A, and a “reference task of past data etc.” which may be asynchronous with the DB of the master server 2A. For example, the “reference task of synchronous data” is executed by an access to the synchronous standby servers (or the master server 2A). In addition, the “reference task of past data etc.” is executed by an access to the asynchronous standby servers (or the master server 2A or the synchronous standby servers).

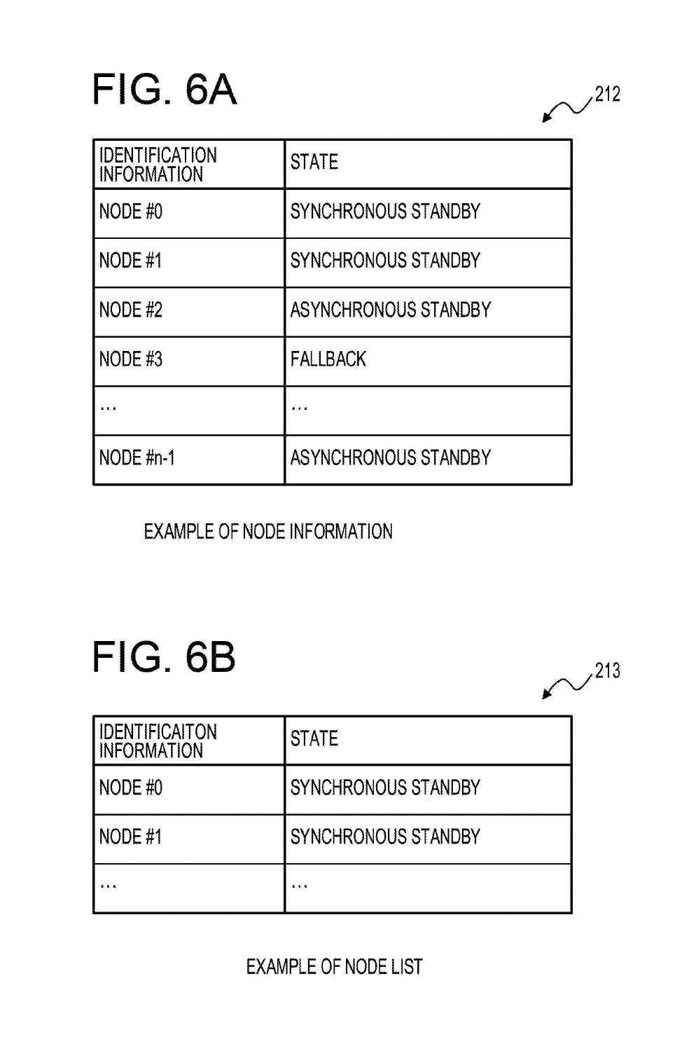

The update process and the synchronization process by the master server 2A and the standby servers 2B may be the same as the processes by the master server 200A and the standby servers 200B illustrated in FIG. 1 or 2. In an embodiment, it is assumed that the update process and the synchronization process by the master server 2A and the standby servers 2B are executed by the method that refers to the node list 213 (see FIG. 6B), as in the processes by the master server 200A illustrated in FIG. 1.

The node 3 is, for example, an application (AP) server. The node 3 may provide an interface (IF) to the cluster system 1, for the terminal 4 or another terminal. In the following description, the node 3 may be referred to as an “AP server 3.”

In addition, while the example of FIG. 3 represents that the cluster system 1 includes one AP server 3, the present disclosure is not limited thereto. The cluster system 1 may include multiple AP servers 3 as a redundant configuration, for example, a cluster configuration.

The AP server 3 and each of the multiple DB servers 2 may be connected to each other to be able to communicate with each other via a network 1b. The network 1b may be, for example, an interconnector which is the same as or different from the network 1a (e.g., LAN).

The terminal 4 is a computer which is used by a user of the DB provided by the cluster system 1. The terminal 4 may be an information processing apparatus such as a PC, a server, a smart phone, or a tablet. For example, the terminal 4 may access the DB servers 2 via the network 5 and the AP server 3 so as to execute the update task or the reference task of the DB.

The network 5 may be at least either the Internet or an intranet including, for example, a LAN, a wide area network (WAN), and a combination thereof. In addition, the network 5 may include a virtual network such as a virtual private network (VPN). In addition, the network 5 may be formed by one or both of a wired network and a wireless network.

### <1-3> Example of Configuration

Next, an example of a functional configuration of the cluster system 1 will be described.

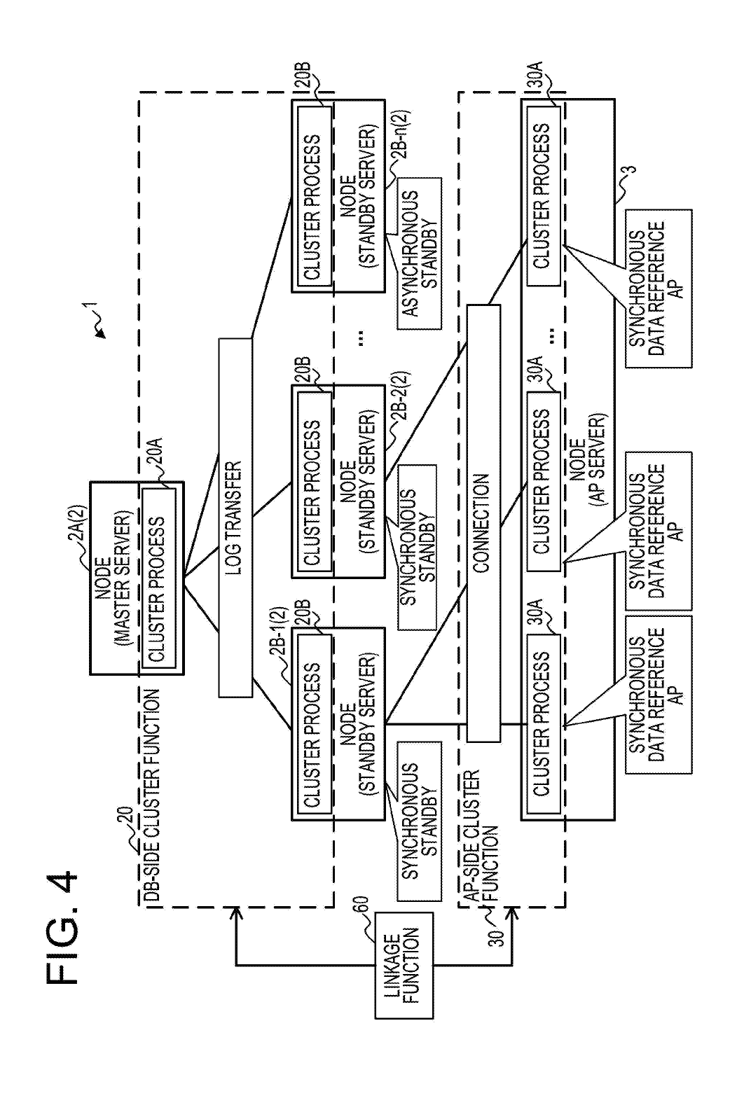

FIG. 4 is a block diagram illustrating an example of a functional configuration of the cluster system 1. As illustrated in FIG. 4, the cluster system 1 may include, for example, a DB-side cluster function 20 in the multiple nodes 2, an AP-side cluster function 30 in the AP server 3, and a linkage function 60 that executes a linkage between the DB-side cluster function 20 and the AP-side cluster function 30.

The DB-side cluster function 20 may include a cluster process 20A that is executed by the master server 2A and a cluster process 20B that is executed by each standby server 2B.

In addition, the AP-side cluster function 30 may include one or more cluster processes 30A that are executed by the AP server 3. In addition, each cluster process 30A receives the reference task of the synchronous data from the terminal 4, processes the corresponding reference task, and transmits a response including the process result to the terminal 4.

For example, the linkage function 60 may be software that is executed by the nodes 2 or the node 3, or software that is distributed in the nodes 2 and the node 3 and executed by the nodes 2 and the node 3.

The DB-side cluster function 20, the AP-side cluster function 30, and the linkage function 60 may be implemented by cluster software that performs, for example, a control or management of a cluster, rather than the DBMS. For example, in order to accomplish both the stabilization of the update task in the master server 2A and the stabilization of the reference task of the synchronous data in the standby servers 2B, the cluster system 1 according to an embodiment may execute the following processes by the cluster function, rather than the DBMS.

(1) The DB-side cluster function 20 uses a log transfer efficiency of the standby servers 2B as a criterion for selecting the upgrade from the asynchronous standby to the synchronous standby or the downgrade from the synchronous standby to the asynchronous standby or stop state.

(2) The DB-side cluster function 20 controls and performs the upgrade from the asynchronous standby to the synchronous standby or the downgrade from the synchronous standby to the asynchronous standby or stop state.

(3) The AP-side cluster function 30 executes the reference task of the synchronous data via the cluster function.

(4) The linkage function 60 links (2) and (3) described above to each other.

According to (1) and (2) above, the DB-side cluster function 20 may implement the continuation of the task such as the update task by optimizing the control of failover or fallback, and may implement the stable task operation by, for example, the appropriate selection of the synchronous standby servers.

According to (4) above, the linkage function 60 notifies the AP-side cluster function 30 of, for example, the result of the state transition of the nodes 2 that has been executed by the DB-side cluster function 20 in (1) and (2) above. Further, for example, the linkage function 60 requests the AP-side cluster function 30 to perform an AP reconnection according to the state transition of the synchronous standby.

In this way, since the linkage function 60 links the DB-side cluster function 20 and the AP-side cluster function 30 to each other, the AP server 3 may reliably perform the reference task of the synchronous data to the standby servers 2B with which the data synchronization has been taken, so that the access to the synchronous data may be guaranteed.

<1-3-1> Example of Configuration of DB Server

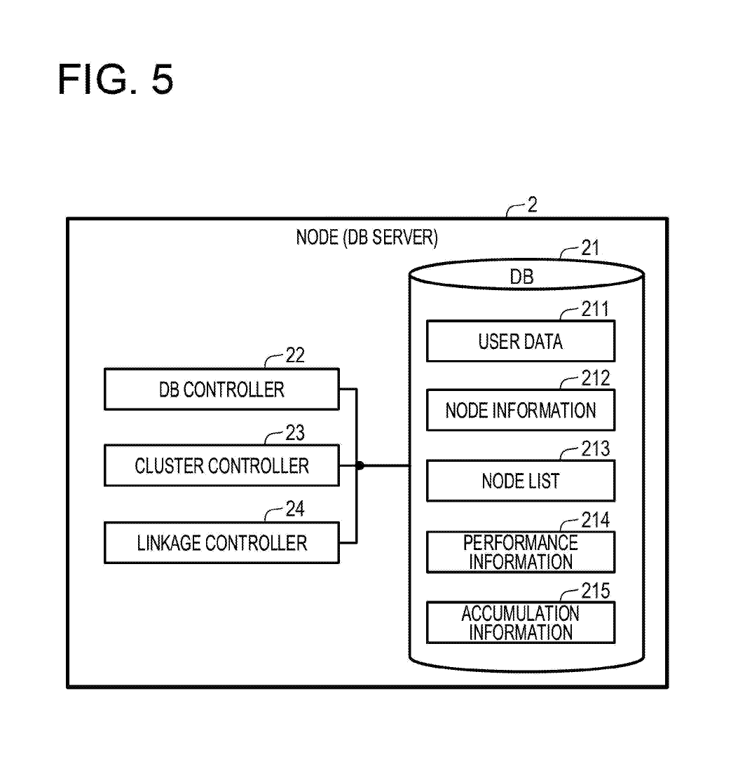

Next, an example of a functional configuration of the DB server 2 according to an embodiment will be described with reference to FIG. 5. Since the node 2 illustrated in FIG. 5 may operate as any of a master server, a synchronous standby server, or an asynchronous standby server by the switch of the synchronization modes, an example of a function configuration including the synchronization modes will be described. In addition, the function of each node 2 may be limited to a function for implementing one or two of the synchronization modes according to, for example, the configuration, environment or operation of the cluster.

As illustrated in FIG. 5, the node 2 may include, for example, a DB 21, a DB controller 22, a cluster controller 23, and a linkage controller 24.

The DB 21 is a database provided by the cluster system 1, and may store user data 211 such as task data. In addition, the user data 211 stored in the DB 21 of the master server 2A may be treated as master data, and the user data 211 stored in each standby server 2B may be treated as synchronous backup or asynchronous backup of the master data.

In addition, according to an embodiment, the DB 21 may store, for example, node information 212, a node list 213, performance information 214, and accumulation information 215. In addition, the user data 211, the node information 212, the node list 213, the performance information 214, and the accumulation information 215 may be stored in one DB 21, or may be distributed and stored in multiple DBs 21 (not illustrated).

The DB controller 22 performs various controls related to the DB 21 which include, for example, the update process and the reference process described above, and may be, for example, one function of the DBMS.

Further, the DB controller 22 of the master server 2A may refer to, for example, the node information 212 stored in the DB 21 (see FIG. 6A), to determine the synchronization mode of each of the multiple standby servers 2B.

FIG. 6A is an example of the node information 212. As illustrated in FIG. 6A, the node information 212 may include, for example, an item of identification information for identifying each node 2 and an item of the state of the corresponding node 2. The state of the node 2 may include the stop state in which the node 2 is stopped, and the state in which the node 2 is degenerated by, for example, the failover or fallback (see “node #3” in FIG. 6A), in addition to the synchronization mode. In addition, the node information 212 may include information (entry) of the “master (primary).” In the node information 212, the state of the node 2 may be updated according to, for example, the startup of the node 2, or the synchronization mode switching process, the failover process or the fallback process by the cluster controller 23 to be described later.

In addition, the master server 2A may manage the node list 213 (see FIG. 6B). FIG. 6B is a view illustrating an example of the node list 213. As illustrated in FIG. 6B, the node list 213 may be a list obtained by extracting the nodes 2 of which the synchronization modes are “synchronous standby” from the node information 212. In addition, the item of “state” may be omitted. For example, the node list 213 may be referred to by the master server 2A to determine whether responses to the synchronization process are returned from all of the synchronization modes, in the update task. The contents of the node list 213 may be updated in synchronization with the update of the node information 212.

When the responses to the update log transmitted in the synchronization process are received from all of the nodes 2 in the “synchronous standby” state identified by the node information 212 or the node list 213, the master server 2A may terminate the update transaction.

The cluster controller 23 performs various controls related to the switch of the synchronization modes of the nodes 2, and is an example of the DB-side cluster function 20 illustrated in FIG. 4.

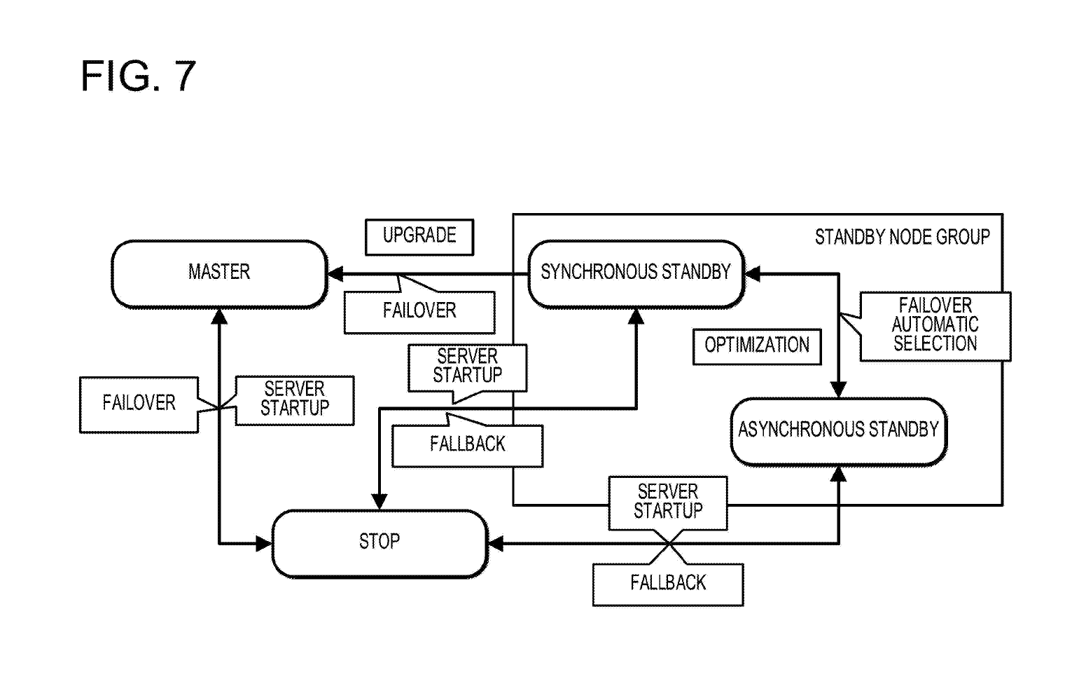

FIG. 7 is a view illustrating an example of a DB instance state transition (the switch of the synchronization modes) according to an embodiment.

As illustrated in FIG. 7, the cluster controller 23 may perform the failover process or the fallback process according to, for example, a failure or a power-off control in the node 2, so as to switch the state of the node 2 from “master,” “synchronous standby” or “asynchronous standby” to “stop.”

In addition, the cluster controller 23 may switch the state of the node 2 from “stop” to “asynchronous standby” according to, for example, a failure recovery, assembling or a power-on control in the node 2. In addition, in FIG. 7, the arrow from “stop” to “master” or “synchronous standby” indicates a case where the state of the node 2 that has been switched from “stop” to “asynchronous standby” is changed to the “master” or “synchronous standby” by a state transition afterward.

Further, according to the failover process of the node 2 in the “master” state, the cluster controller 23 may select any one of the multiple nodes 2 in the “synchronous standby” state and switch the selected node 2 to the “master” state. In the upgrade from the “synchronous standby” to the “master,” a synchronous standby server that ranks high in the log transfer performance may be preferentially selected as the switching target node 2, in order to suppress the influence of the reconstruction of the state (synchronization modes) on the update task.

In addition, the number of the nodes 2 in the “synchronous standby” state may decrease due to the state transition accompanied by the failover process or the fallback process described above. In this case, according to the decrease of the number of the nodes 2 in the “synchronous standby” state, the cluster controller 23 may select any one of the nodes 2 in the “asynchronous standby” state and switch the selected node 2 to the “synchronous standby” state.

In the upgrade from the “asynchronous standby” to the “synchronous standby,” for example, an asynchronous standby server that ranks high (e.g., ranks highest) in the log transfer performance may be preferentially selected as the switching target node 2.

Further, the cluster controller 23 may execute the switch (reconstruction) of the state based on a priority among the standby node group in the “synchronous standby” or “asynchronous standby” state. In addition, the switch of the state between the “synchronous standby” and the “asynchronous standby” may be executed by changing the control information managed by the master server 2A without stopping the task.

For example, the cluster controller 23 may acquire the log transfer performance of each standby server 2B that is collected by the DBMS, at a predetermined time interval, and store the acquired log transfer performance in the performance information 214 of the DB 21.

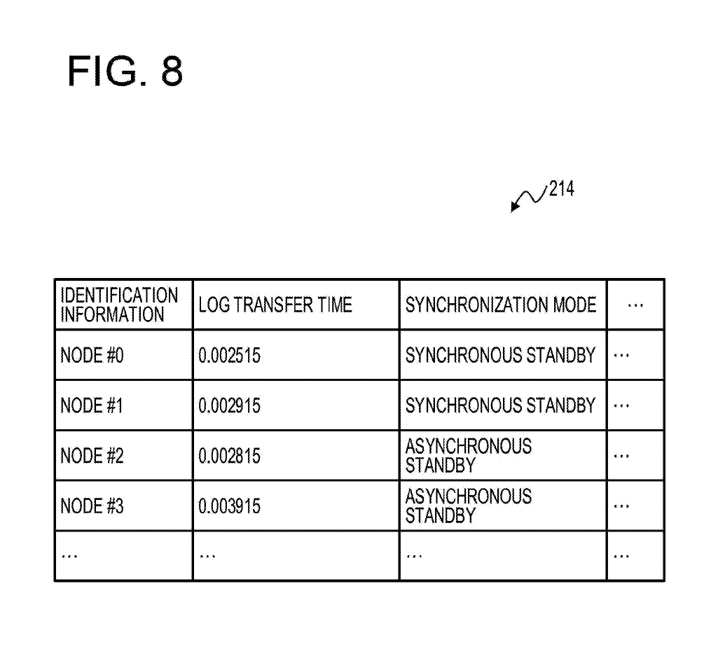

FIG. 8 illustrates an example of the performance information 214. The performance information 214 may include, for example, an item of identification information of the node 2, an item of a log transfer time which is an example of the log transfer performance, and an item of the synchronization mode of the node 2. In addition, the performance information 214 may include various pieces of information such as a time stamp indicating the time of collection of the log transfer performance by the DBMS, in addition to the information illustrated in FIG. 8.

In addition, as for the log transfer time, any of the following times (i) to (iii) may be used. In an embodiment, it is assumed that the following time (ii) is used.

(i) “write_lag”

The “write_lag” is the time until the write to the WAL of the standby server 2B (synchronous standby server) is completed after the write to the WAL of the master server 2A.

(ii) “flush_lag”

The “flush_lag” is the time until the guarantee of nonvolatilization of the standby server 2B (synchronous standby server) is completed, in addition to “write_lag” in (i) above.

(iii) “replay_lag”

The “replay_lag” is the time until the WAL of the standby server 2B (synchronous standby server) is reflected on the DB 21 of the corresponding server 2B, in addition to the “flush_lag” of (ii) above.

When the log transfer performance for a predetermined time period is accumulated in the performance information 214, the cluster controller 23 may calculate an average value of the log transfer times accumulated in the performance information 214 for each node 2 as a transfer average time, and may store the calculated transfer average time in the accumulation information 215 of the DB 21. The prescribed time period may be, for example, a time period such as one day.

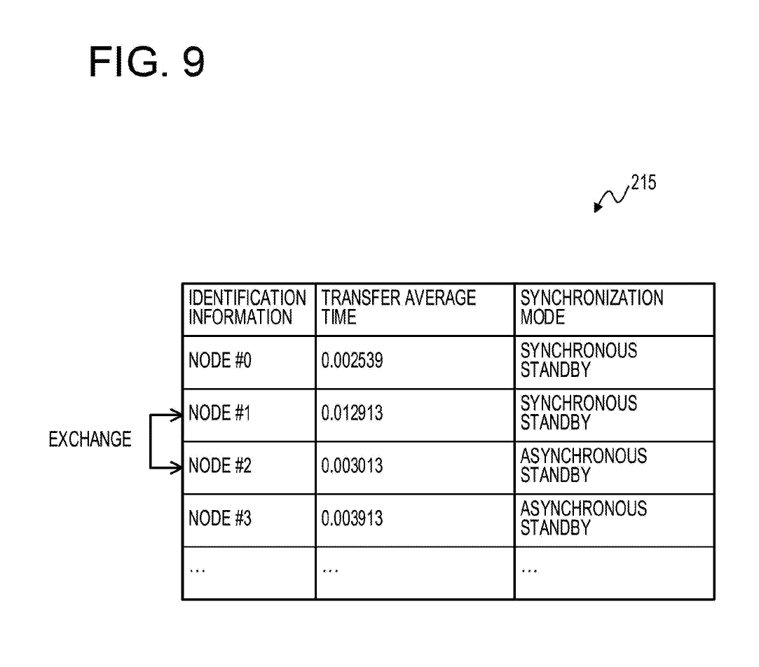

FIG. 9 illustrates an example of the accumulation information 215. The accumulation information 215 may include, for example, an item of identification information of the node 2, an item of a transfer average time, and an item of the synchronization mode of the node 2. In addition, the accumulation information 215 may include various pieces of information such as a time stamp indicating, for example, a calculation time (timing) of the transfer average time, in addition to the information illustrated in FIG. 9.

The cluster controller 23 refers to the accumulation information 215 to determine the node 2 in the “asynchronous standby” state with a smaller transfer average time than that of the node 2 in the “synchronous standby” state.

For example, as illustrated in FIG. 9, the transfer average time of the node #1 in the “synchronous standby” state is “0.012913,” and the transfer average time of the node #2 in the “asynchronous standby” state is “0.003013.” In this case, it may be said that the node #2 rather than the node #1 corresponds to the node 2 that has the relatively smaller transfer average time and the relatively higher log transfer performance. Thus, the cluster controller 23 performs a control to change the synchronization mode of the node #1 into the “asynchronous standby” and change the synchronization mode of the node #2 into the “synchronous standby,” and simultaneously, updates the node information 212 and the node list 213.

In addition, the process of calculating (updating) the accumulation information 215 and the process of switching the synchronization mode may be executed when the log transfer time of the node 2 in the “synchronous standby” state exceeds a threshold, in addition to when the log transfer performance for a predetermined time period is accumulated. For example, after the performance information 214 is acquired, the cluster controller 23 determines whether the log transfer time of the node 2 in the “synchronous standby” state exceeds the threshold, and when it is determined that the log transfer time exceeds the threshold, the cluster controller 23 may perform the process of calculating (updating) the accumulation information 215 and the process of switching the synchronization mode.

As described above, according to the cluster controller 23, by changing (upgrading) the asynchronous standby server with the high log transfer performance to the synchronous standby server, it is possible to reduce the log transfer latency from the synchronous standby server to the master server 2A. Accordingly, the process delay or the process load in the master server 2A may be reduced, so that the stable operation of the update task in the master server 2A may be implemented.

In addition, the cluster controller 23 may switch the synchronization mode based on, for example, statistical information on the performance of the node 2 described below, instead of the performance information 214 and the accumulation information 215. As for the statistical information, there may be various kinds of information such as, the number of the latest WAL versions applied to the respective nodes 2, a throughput of each node 2 for a past specific time period (e.g., a process amount per unit time), and a central processing unit (CPU) usage rate.

The processes performed by the cluster controller 23 described above may be executed by the cluster controller 23 of the master server 2A (or the switched master server 2A when the master server 2A has been switched) when the master server 2A is normal.

Alternatively, in order to implement the stabilization of the update task of the master server 2A, the processes performed by the cluster controller 23 described above may be executed in cooperation with the cluster controllers 23 of the multiple DB servers 2. The multiple DB servers 2 that execute the processes in the cooperative manner may include the multiple standby servers 2B (synchronous standby servers and/or asynchronous standby servers) or may include the master server 2A.

In addition, for example, the processes performed by the cluster controller 23 described above may be executed in cooperation with the cluster controllers 23 of the multiple standby servers 2B until the failover is completed after a failure occurs in the master server 2A.

In addition, in order to secure the simultaneous failure durability, when a failure occurs in the multiple nodes 2, the cluster system 1 according to an embodiment may execute the above-described processes in combination with each other, based on the number of nodes 2 in which the failure occurs or the synchronization modes of the nodes 2 in which the failure occurs.

For example, when a failure occurs in multiple synchronous standby servers, the cluster controller 23 of the master server 2A may switch the synchronization modes of the asynchronous standby servers that correspond to (are equal to) the number of synchronous standby servers in which the failure occurs, to the synchronous standby.

In addition, the number of nodes of “synchronous standby” may be set by, for example, the system administrator at the timing of, for example, the startup or the initial setting of the cluster system 1. The cluster controller 23 may control the number of the nodes 2 in the “synchronous standby” state to correspond to the set number of nodes of synchronous standby.

In addition, when a failure occurs in the master server 2A and one or more synchronous standby servers, a switch control may be performed according to the following procedures (i) and (ii).

(i) As described above, the cluster controllers 23 of the multiple synchronous standby servers cooperate with each other to upgrade one standby server 2B to a new master server 2A.

(ii) The new master server 2A switches the synchronization modes of the asynchronous standby servers that correspond to the number of synchronous standby servers obtained by adding “1” (which is the reduced synchronous standby server in (i) above) to the number of one or more synchronous standby servers in which the failure occurs, to the synchronous standby.

When the state transition of the nodes 2 (e.g., the switch of the synchronization modes) is performed by the cluster controller 23, the linkage controller 24 makes a notification to the AP server 3 based on the updated node information 212 (or node list 213).

For example, the linkage controller 24 may transmit the node information 212 (or the node list 213) to the AP server 3, or makes a notification to the AP server 3 according to the state change of the nodes 2 detected based on the node information 212 (or the node list 213). In the following description, a case where the linkage controller 24 makes a notification according to the state change of the nodes 2 will be described as an example.

In addition, the state change may be, for example, a change related to at least one of the failover, the fallback, and the synchronization state of the server 2. The change related to the synchronization state of the servers 2 include, for example, a change of the servers 2 which becomes the synchronous standby state with respect to the master server 2A based on the change of the log transfer time.

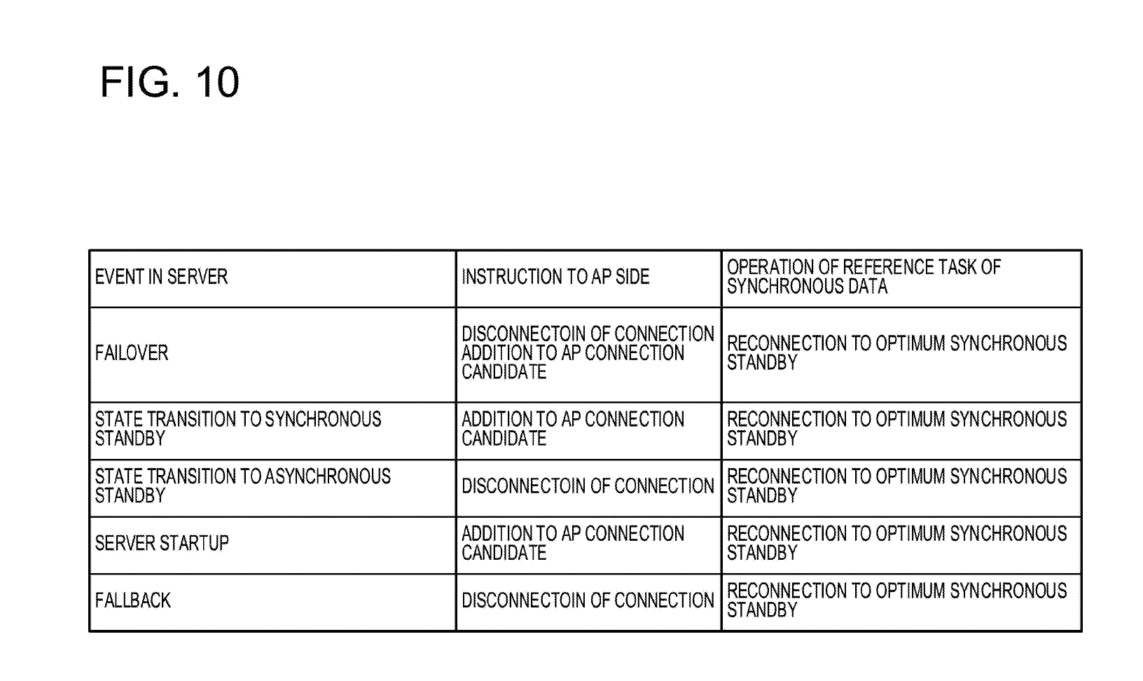

FIG. 10 is a view illustrating an example of a process according to the state transition of the node 2. As illustrated in FIG. 10, the linkage controller 24 may instruct to “disconnect a connection” or to “add to AP connection candidate” with regard to the node 2, as the notification to the AP server 3.

The instruction to “disconnect a connection” is a request for disconnecting the connection established by the AP server 3 between the AP server 3 and the standby servers 2B (or the master server 2A) in order to perform the reference process of the synchronous data.

The instruction to “add to AP connection candidate” is a request for adding the node 2 to the connection destination candidate for performing the reference process of the synchronous data by the AP. The node 2 added to the AP connection candidates becomes the node 2 of the candidate for the establishment of the connection by the AP server 3 and the reference process of the synchronous data.

The relationship between the scene where the instructions to “disconnect a connection” and “add to AP connection candidate” (see FIG. 10) are performed and the node 2 of the disconnection or addition target is as follows.

When a Failover of the Node 2 Occurs

In this case, the linkage controller 24 instructs the “addition to AP connection candidate” to the AP server 3, to add the asynchronous standby server upgraded to the synchronous standby, instead of the synchronous standby server upgraded to the master server 2A, to the AP connection candidate.

Further, in this case, when the reference task of the synchronous data to the master server 2A is not permitted, the linkage controller 24 instructs to “disconnect a connection” to the AP server 3, to disconnect the connection with the synchronous standby server upgraded to the master server 2A.

Meanwhile, when the reference task of the synchronous data to the master server 2A is permitted, the linkage controller 24 instructs to “disconnect a connection” to the AP server 3, to disconnect the connection with the master server 2A in which the failure occurs (the node 2 that has transitioned to the stop state).

When a State Transition to the Synchronous Standby Occurs

For example, when the state of the node 2 transitions from the asynchronous standby to the synchronous standby, the linkage controller 24 instructs the “addition to AP connection candidate” to the AP server 3, to add the node 2 transitioned to the synchronous standby state to the AP connection candidate.

When a State Transition to the Asynchronous Standby Occurs

For example, when the state of the node 2 transitions from the synchronous standby to the asynchronous standby, the linkage controller 24 instructs to “disconnect a connection” to the AP server 3, to disconnect the connection with the node 2 transitioned to the asynchronous standby state.

When a Fallback of the Node 2 Occurs

In this case, the linkage controller 24 instructs to “disconnect a connection” to the AP server 3, to disconnect the connection with the node 2 in which the fallback occurs (the node 2 transitioned to the stop state).

<1-3-2> Example of Configuration of AP Server

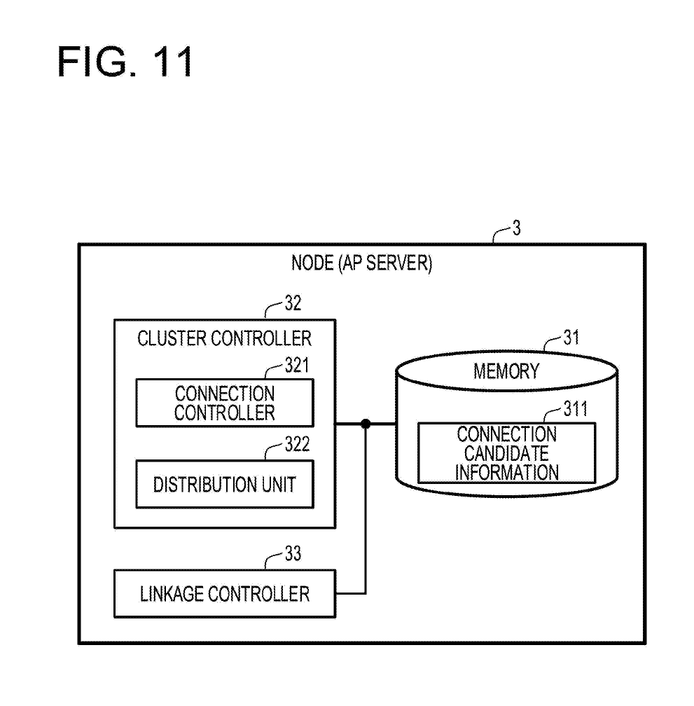

Next, an example of a functional configuration of the AP server 3 according to an embodiment will be described with reference to FIG. 11. As illustrated in FIG. 11, the node 3 may include, for example, a memory unit 31, a cluster controller 32, and a linkage controller 33.

Together with the linkage controller 24, the linkage controller 33 is an example of the linkage function 60 illustrated in FIG. 4. The linkage controller 33 receives an instruction from the linkage controller 24 of the node 2, and transfers the received instruction to the cluster controller 32.

When the linkage controller 24 transmits the node information 212 (or the node list 213) itself to the AP server 3, the linkage controller 33 may perform the processes described as the functions of the linkage controller 24 above based on, for example, the node information 212 received from the linkage controller 24. For example, the linkage controller 33 may detect the state change of the node 2 and instruct to “disconnect a connection” or “add to AP connection candidate” to the cluster controller 32 according to the detected state change.

In addition, any one of the linkage controller 24 and the linkage controller 33 may be omitted. For example, in a case where the linkage controller 24 is omitted, when the node information 212 (or the node list 213) is updated, the cluster controller 23 of the DB server 2 may transmit the corresponding node information 212 (or the corresponding node list 213) to the AP server 3. In addition, in a case where the linkage controller 33 is omitted, the cluster controller 32 may receive the node information 212 (or the node list 213) or an instruction from the linkage controller 24.

As described above, each of the linkage controllers 24 and 33 is an example of a first identifying unit that, when a change of the state of one or more servers 2 included in the standby servers 2B is detected, identifies a synchronous standby server from the servers 2 included in the standby servers 2B after the detection of the change.

The memory unit 31 stores various kinds of information used by the AP server 3 for controlling the AP. For example, the memory unit 31 according to an embodiment may store connection candidate information 311 as the information used for the processes of the cluster controller 32 and the linkage controller 33.

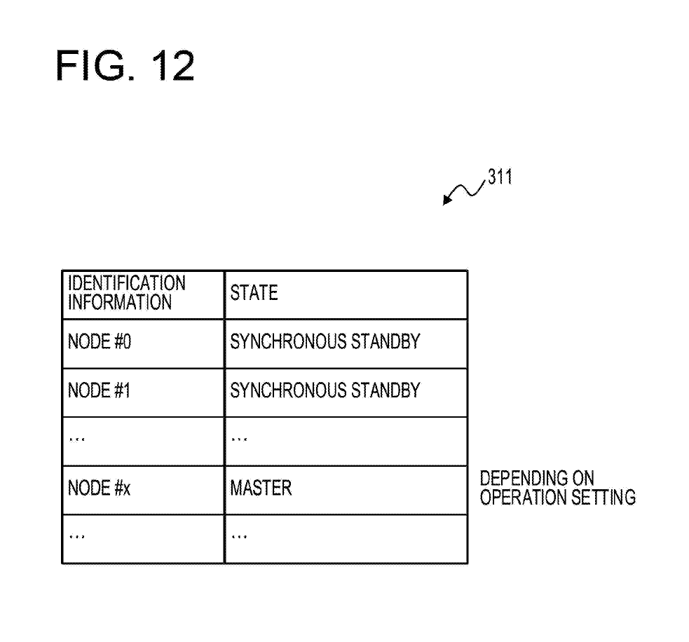

FIG. 12 illustrates an example of the connection candidate information 311. The connection candidate information 311 is information indicating the node 2 which becomes the connection destination (reference destination) candidate for the reference task of the synchronous data, and may include, for example, identification information of the connection candidate node 2 and the state of the node 2. The state of the connection candidate node 2 may be, for example, “synchronous standby.” In addition, when the operation setting permits the master server 2A to become the connection destination of the reference process of the synchronous data, the node 2 of the “master” (“node #x” in the example of FIG. 12) may be set in the connection candidate information 311.

In addition, the connection candidate information 311 may include identification information and the state of the node 2 which becomes the connection destination candidate for the reference task of the asynchronous data (e.g., an asynchronous standby server). The connection candidate information 311 may be the same as the node information 212. In this case, the AP server 3 may be notified of the node information 212 from the node 2 (the linkage controller 24), and store the notified node information 212 as the connection candidate information 311 in the memory unit 31. Alternatively, the connection candidate information 311 may be the same as the node list 213. In this case, the AP server 3 may be notified of the node list 213 from the node 2 (the linkage controller 24), and store the notified node list 213 as the connection candidate information 311 in the memory unit 31.

The cluster controller 32 performs various controls related to the switch of the synchronization mode of the node 2, and is an example of the AP-side cluster function 30 illustrated in FIG. 4.

As illustrated in FIG. 11, the cluster controller 32 may include, for example, a connection controller 321 and a distribution unit 322.

The connection controller 321 may control the connection candidate information 311 and a connection, according to a notification from the linkage controller 24. For example, when the instruction to “add a specific node 2 to a connection candidate” is received from the linkage controller 24, the connection controller 321 may set the corresponding node 2 to be valid for the reference task of the synchronous data, in the connection candidate information 311. The setting to make the node 2 valid in the connection candidate information 311 may include adding an entry of the corresponding node 2 to the connection candidate information 311 or changing the state of the corresponding node 2 to the synchronous standby.

In addition, the connection controller 321 may instruct the AP (e.g., the cluster process 30A; see FIG. 4) to establish a connection with the node 2 added to the connection candidate. The instruction to cause the AP to establish the connection may be notified to the terminal 4 such that an instruction to execute the establishment of the connection may be made from the terminal 4 to the AP.

As described above, the connection controller 321 is an example of a first requesting unit that, when a change of the state of the server 2 is detected, requests the terminal 4 to perform a connection with the server 2 in the synchronous standby state with the master server 2A after the detection of the change.

In addition, when the instruction to “disconnect a connection” with a specific node 2 is received from the connection controller 24, the connection controller 321 may update the connection candidate information 311 so as to make the corresponding node 2 invalid for the reference task of the synchronous data. The setting to make the node 2 invalid in the connection candidate information 311 may include deleting an entry of the corresponding node 2 from the connection candidate information 311 or changing the state of the corresponding node 2 to the asynchronous standby state or the stop state.

In addition, the connection controller 321 may instruct the AP (e.g., the cluster process 30A; see FIG. 4) to disconnect a connection with the node 2. The instruction to cause the AP to disconnect the connection may be notified to the terminal 4 such that an instruction to execute the disconnection of the connection may be made from the terminal 4 to the AP. In addition, the disconnection of the connection may be performed for all the nodes 2 established to be connected with the terminal 4 (AP), and thereafter, the reestablishment of the connection with the synchronous standby server after the change of the state may be performed. Alternatively, the disconnection of the connection may be performed for the node 2 designated as the disconnection target.

As described above, when a change of the state of the server 2 is detected, the connection controller 321 which is an example of the first requesting unit may request the terminal 4 to disconnect the connection with the server 2 included in the standby servers 2B.

The distribution unit 322 refers to the connection candidate information 311, and distributes the server 2 which becomes an access target, in response to a request for an access to the cluster system 1 that has been received from the terminal 4 (e.g., an update request related to the update task or a reference request related to the reference task).

As an example, when a request for information of a connection destination of the AP is received from the cluster process 30A of the application operating by the AP server 3, the distribution unit 322 may determine whether the states of the servers 2 which are being connected (have been established to be connected) with the AP server 3 (the terminal 4) have been changed. When a change of the states of the servers 2 being connected (e.g., a change to the asynchronous standby state or the stop state) is detected, the distribution unit 322 may extract the servers 2 of the connection destination candidates registered in the connection candidate information 311. The servers 2 of the connection destination candidates are, for example, the servers 2 of the “synchronous standby” (and “master”) in a case of the reference task of the synchronous data.

Then, the distribution unit 322 may identify one of the extracted servers 2 and notify the information of the identified server 2 to the cluster process 30A. In addition, as for the method of identifying one of the multiple synchronous standby servers, various known methods (e.g., load balancing) may be used.

In addition, the distribution unit 322 may instruct to disconnect the connection with the servers 2 which are being connected with the AP server 3 (the terminal 4) and in which the state change is detected. In addition, as described above, the disconnection of the connection may be made for all the nodes 2 which have been established to be connected with the terminal 4 (AP), and thereafter, the reestablishment of the connection with the synchronous standby server after the change of the state may be performed.

As described above, according to the distribution unit 322, when the terminal 4 performs the reference task of the synchronous data, the reconnection with other servers 2 is performed according to the synchronous state of the server 2 being connected with the terminal 4, so that the reference task of the synchronous data may be reliably performed.

As described above, the distribution unit 322 is an example of a second identifying unit that, when a change of the state of the server 2 being connected with the terminal 4 is detected, identifies a synchronous standby server from the servers 2 included in the standby servers 2B after the detection of the change. In addition, each of the linkage controllers 24 and 33 and the distribution unit 322 is an example of an identifying unit.

In addition, the distribution unit 322 is an example of a second requesting unit which, when a change of the state of the server 2 being connected with the terminal 4 is detected, requests the terminal 4 to perform a connection with the server 2 in the synchronous standby state with the master server 2A after the detection of the change. In addition, each of the connection controller 321 and the distribution unit 322 is an example of a requesting unit. When a change of the state of the server 2 being connected with terminal 4 is detected, the distribution unit 322 as an example of the second requesting unit may request the terminal 4 to disconnect the connection with the server 2 included in the standby servers 2B.

### <1-4> Example of Operation

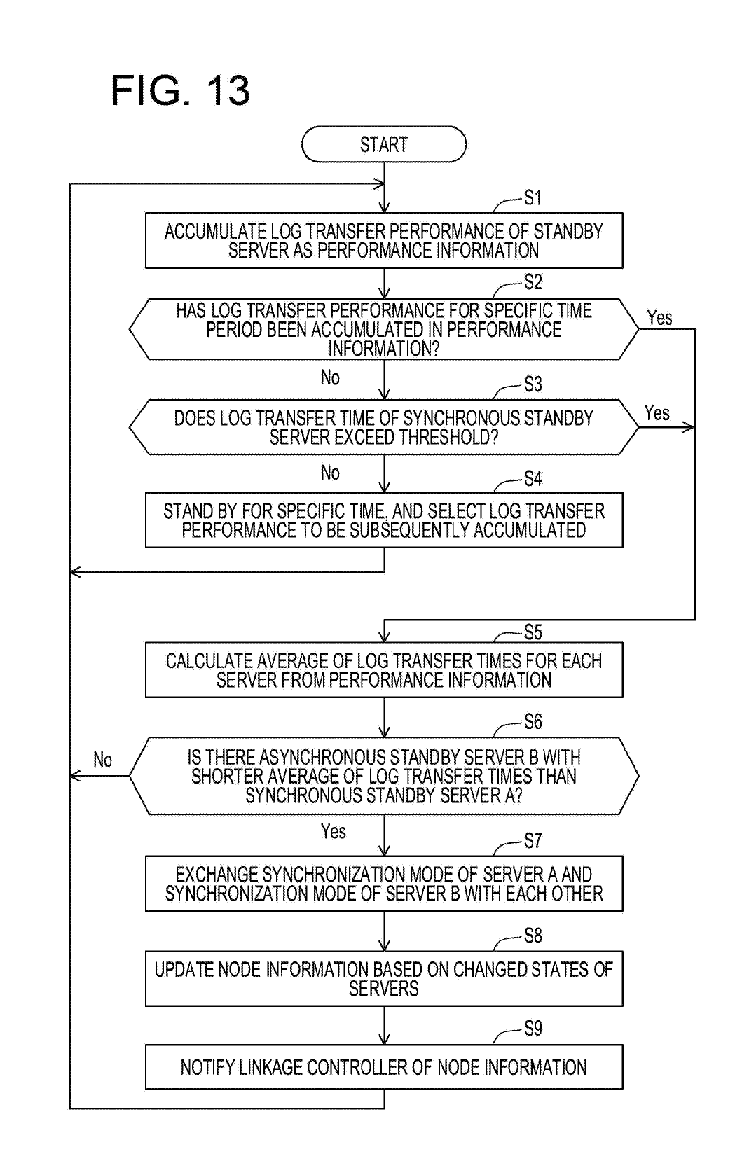

Next, an example of the operation of the cluster system 1 configured as described above will be described with reference to FIGS. 13 to 20.

<1-4-1> Example of Operation of Cluster Controller of DB Server

First, an example of the operation of the cluster system 23 of the DB server 2 will be described with reference to FIGS. 13 to 17

Synchronization Mode Switching Process

As illustrated in FIG. 13, the cluster controller 23 of the DB server 2 acquires the log transfer performance of the standby server 2B that is measured by the DBMS, and accumulates the acquired log transfer performance as the performance information 214 in the DB 21 (step S1).

The cluster controller 23 determines whether the log transfer performance for a specific time period (e.g., one day) has been accumulated in the performance information 214 (step S2). When it is determined that the log transfer performance for the specific time period has not been accumulated (“No” in step S2), the cluster controller 23 refers to the performance information 214 and determines whether the log transfer time of the synchronous standby server exceeds a threshold (step S3).

When it is determined that the log transfer time of the synchronous standby server does not exceed the threshold (“No” in step S3), the cluster controller 23 stands by for a specific time (e.g., a few minutes to a few hours), and selects the log transfer performance to be subsequently accumulated (step S4). Then, the process proceeds to step S1.

Meanwhile, when it is determined in step S2 that the log transfer performance for the specific time period has been accumulated in the performance information 214 (“Yes” in step S2), the process proceeds to step S5. In addition, when it is determined in step S3 that the log transfer time of the synchronous standby server exceeds the threshold (“Yes” in step S3), the process proceeds to step S5.

In step S5, the cluster controller 23 calculates the average of the log transfer times for each server 2 from the performance information 214, and generates or updates the accumulation information 215.

Next, the cluster controller 23 refers to the accumulation information 215 to determine whether there exists an asynchronous standby server B having the shorter average of the log transfer times than that of the synchronous standby server A (step S6). When it is determined that such an asynchronous standby server B does not exist (“No” in step S6), the process proceeds to step S1.

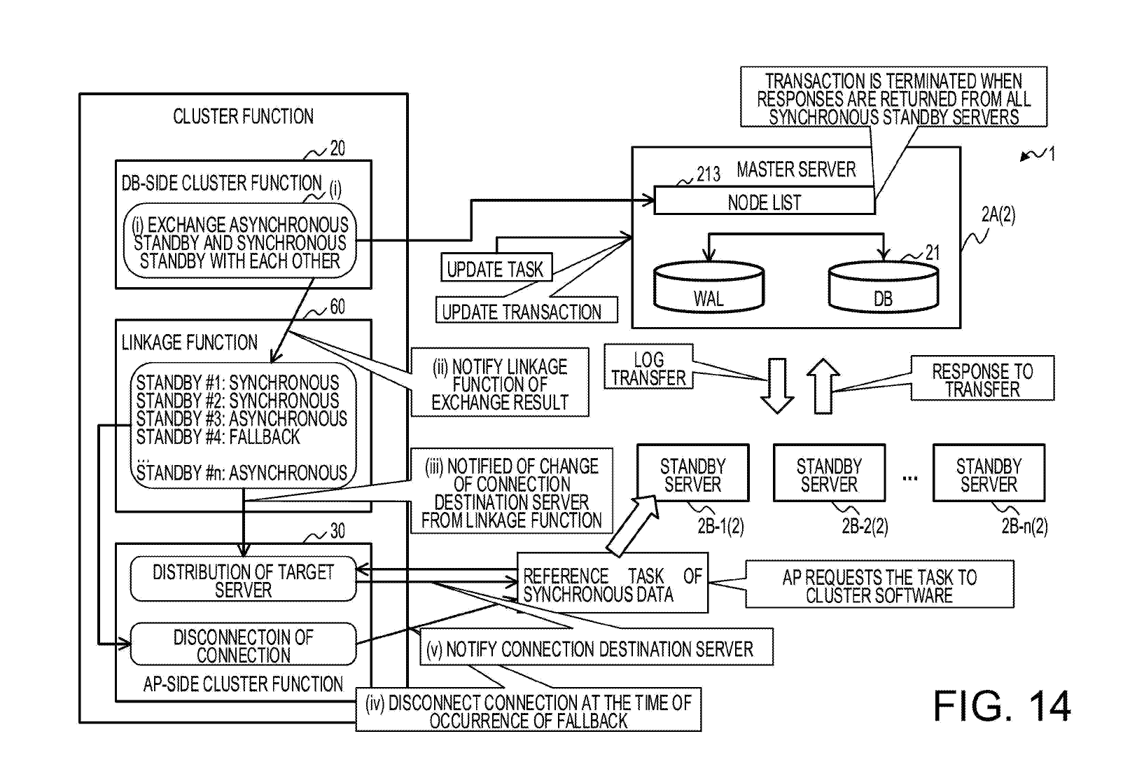

Meanwhile, when it is determined that such an asynchronous standby server B exists (“Yes” in step S6), the cluster controller 23 exchanges the synchronization mode of the server A and the synchronization mode of the server B with each other (step S7; see the numeral (i) in FIG. 14). For example, the cluster controller 23 sets the synchronization mode of the server A to the asynchronous standby, and sets the synchronization mode of the server B to the synchronous standby. In addition, the cluster controller 23 may determine the number of the respective servers A and servers B to be equal to the set number of the synchronous standby servers.

Then, the cluster controller 23 updates the node information 212 and the node list 213 based on the changed state of the server 2 (step S8). Further, the cluster controller 23 notifies the linkage controller 24 of the updated node information 212 (or the updated node list 213) (step S9; refer to the numeral (ii) in FIG. 14), and the process proceeds to step S1.

Failover Process

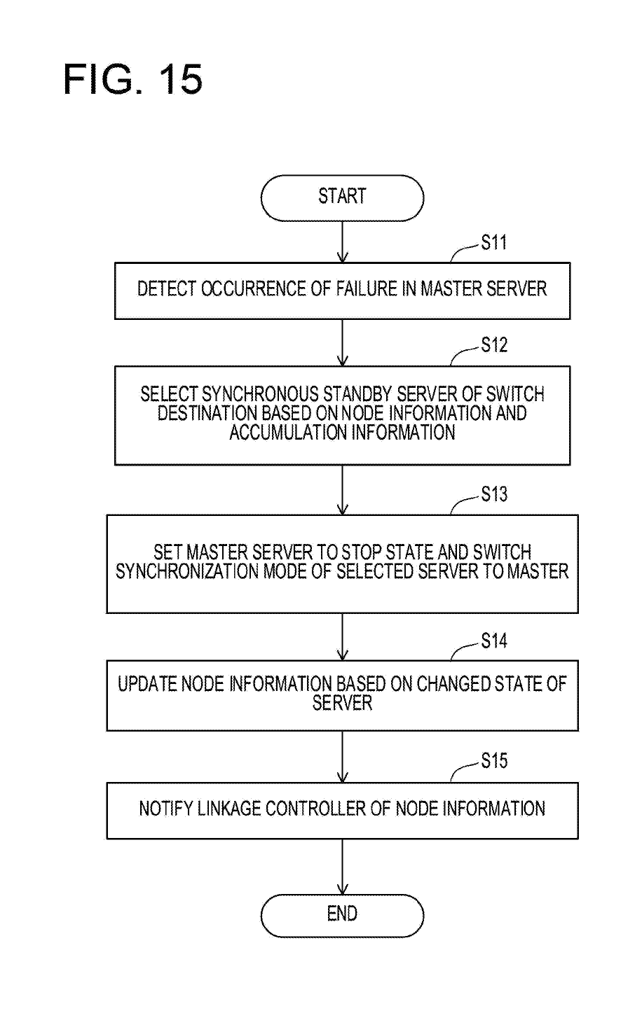

As illustrated in FIG. 15, the cluster controller 23 of the DB server 2 (e.g., the synchronous standby server) detects an occurrence of a failure in the master server 2A (step S11).

Based on the node information 212 and the accumulation information 215, the cluster controller 23 selects a synchronous standby server to be switched to the master (step S12). For example, the cluster controller 23 may identify the synchronous standby servers based on the node information 212, and select a predetermined number of synchronous standby servers from the identified synchronous standby servers in an increasing order of the log transfer time in the accumulation information 215. The predetermined number is the number of servers to be exchanged.

In addition, the cluster controller 23 sets the master server 2A to the stop state, and switches the synchronization modes of the selected servers 2 to the master (step S13).

Then, the cluster controller 23 updates the node information 212 and the node list 213 based on the changed state of the servers 2 (step S14), and notifies the linkage controller 24 of the node information 212 (or the node list 213) (step S15). Then, the process is terminated.

Fallback Process

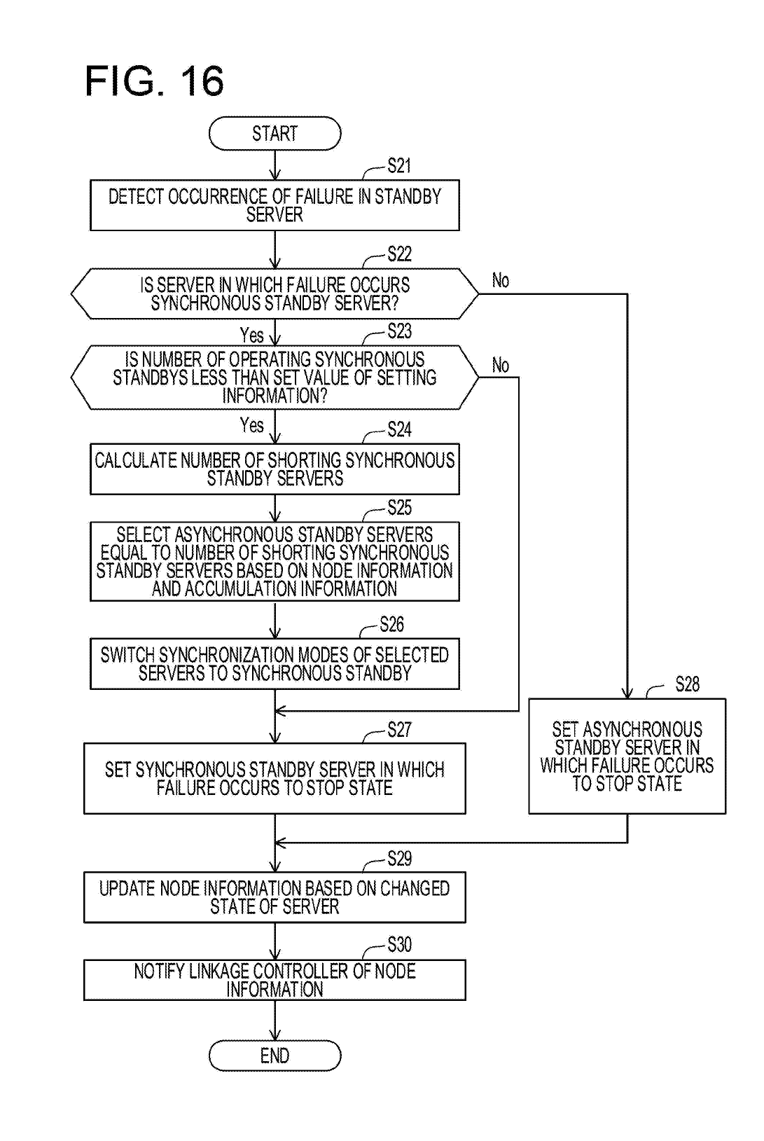

As illustrated in FIG. 16, when an occurrence of a failure is detected in the standby server 2B (step S21), the cluster controller 23 of the DB server 2 determines whether the server 2 in which the failure occurs is a synchronous standby server (step S22).

When it is determined that the server 2 in which the failure occurs is a synchronous standby server (“Yes” in step S22), the cluster controller 23 determines whether the number of operating synchronous standbys is less than a set value in the performance information 214 (step S23). When it is determined that the number of operating synchronous standbys is less than the set value in the performance information 214 (“Yes” in step S23), the cluster controller 23 calculates the number of shorting synchronous standby servers (step S24).

Then, based on the node information 212 and the accumulation information 215, the cluster controller 23 selects asynchronous standby servers that correspond to the number of shorting synchronous standby servers (step S25). For example, the cluster controller 23 may identify asynchronous standby servers based on the node information 212, and select the asynchronous standby servers that correspond to the number of shorting synchronous standby servers, from the identified asynchronous standby servers in an increasing order of the log transfer time in the accumulation information 215.

Next, the cluster controller 23 switches the synchronization modes of the selected servers 2 to the synchronous standby (step S26), and sets the synchronous standby server in which the failure occurs, to the stop state (step S27). Then, the process proceeds to step S29.

In addition, when it is determined in step S23 that the number of operating synchronous standbys is not less than the set value (“No” in step S23), the switch from the asynchronous standby to the synchronous standby is unnecessary. Thus, the process proceeds to step S27.

Meanwhile, when it is determined in step S22 that the server 2 in which the failure occurs is not a synchronous standby server (e.g., the server 2 is an asynchronous standby server) (“No” in step S22), the process proceeds to step S28. In step S28, the cluster controller 23 sets the asynchronous standby server in which the failure occurs, the stop state, and the process proceeds to step S29.

In step S29, the cluster controller 23 updates the node information 212 and the node list 213 based on the changed state of the servers 2 (step S29). Then, the cluster controller 23 notifies the linkage controller 24 of the node information 212 (or the node list 213) (step S30), and the process is terminated.

Server Starting-Up Process

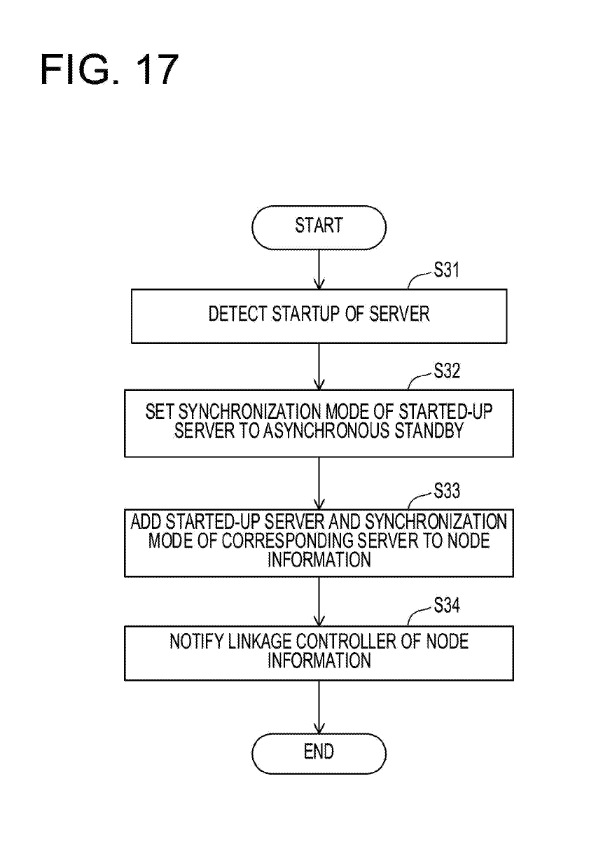

As illustrated in FIG. 17, when a startup of the server 2 is detected (step S31), the cluster controller 23 of the DB server 2 sets the synchronization mode of the started-up server 2 to the asynchronous standby (step S32).

Next, the cluster controller 23 adds the started-up server 2 and the synchronization mode of the server 2 to the node information 212 and the node list 213 (step S33). Further, the cluster controller 23 notifies the linkage controller 24 of the node information 212 (or the node list 213) (step S34), and the process is terminated.

<1-4-2> Example of Operation of Linkage Controller

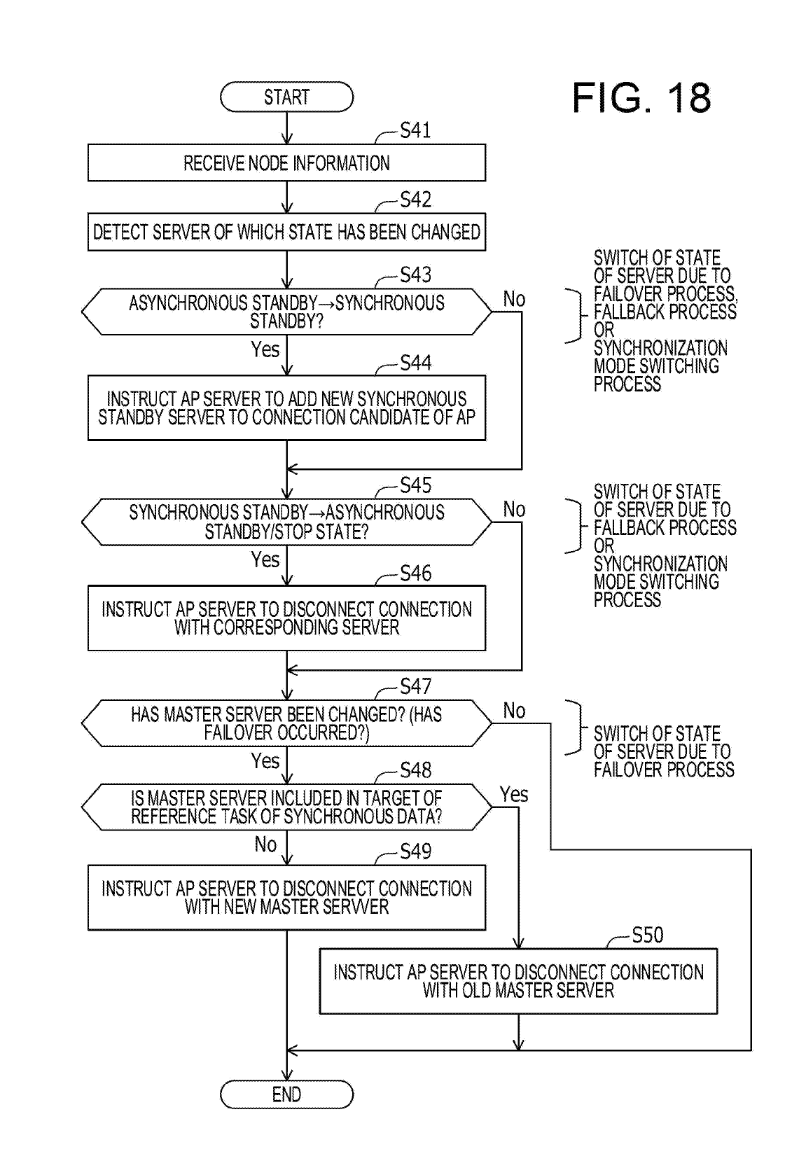

Next, an example of an operation of the linking process by the linkage controller 24 of the DB server 2 will be described with reference to FIGS. 14 and 18. In addition, as described above, the linking function 60 may be distributed and mounted in the linkage controller 24 of the side of the DB server 2 and the linkage controller 33 of the side of the AP server 3, or at least a portion of the following respective processes may be executed by the linkage controller 33 of the AP server 3.

As illustrated in FIG. 18, the linkage controller 24 receives the node information 212 (or the node list 213) from the cluster controller 23 (step S41). In addition, the linkage controller 24 may transmit the received node information 212 (or node list 213) to the cluster controller 32 of the AP server 3. In this case, the processes of the following steps S42 to S50 may be omitted.

Next, the linkage controller 24 detects a server of which state has been changed, based on the node information 212 (step S42).

For example, the linkage controller 24 determines whether the state of the detected server 2 has been changed from the asynchronous standby to the synchronous standby (step S43). When it is determined that the state of the detected server has not been changed from the asynchronous standby to the synchronous standby (“No” in step S43), the process proceeds to step S45. Meanwhile, when it is determined that the state of the detected server 2 has been changed from the asynchronous standby to the synchronous standby (“Yes” in step S43), the linkage controller 24 instructs the AP server 3 to add the new synchronous standby server to the connection candidate of the AP (step S44), and the process proceeds to step S45.

In step S45, the linkage controller 24 determines whether the state of the detected server 2 has been changed from the synchronous standby to the asynchronous standby or the stop state. When it is determined that the state of the detected server 2 has not been changed from the synchronization standby to the asynchronous standby or the stop state (“No” in step S45), the process proceeds to step S47. Meanwhile, when it is determined that the state of the detected server 2 has been changed from the synchronous standby to the asynchronous standby or the stop state (“Yes” in step S45), the linkage controller 54 instructs the AP server 3 to disconnect the connection with the corresponding server 2 (step S46), and the process proceeds to step S47.

In step S47, the linkage controller 24 determines whether the master server 2A has been changed, in other words, whether a failover has occurred, based on the node information 212. When it is determined that a failover has not occurred (“No” in step S47), the process is terminated.

When it is determined that the master server 2A has been changed (“Yes” in step S47), the linkage controller 24 determines whether the master server 2A is included in the target of the reference task of the synchronous data in the operation setting (step S48). When it is determined that the master server 2A is not included in the target of the reference task of the synchronous data (“No” in step S48), the linkage controller 24 instructs the AP server 3 to disconnect the connection with the new master server 2A (step S49), and the process is terminated.

Meanwhile, when it is determined that the master server 2A is included in the target of the reference task of the synchronous (“Yes” in step S48), the linkage controller 24 instructs the AP server 3 to disconnect the connection with the old master server 2A (step S50), and the process is terminated.

In addition, the change from the asynchronous standby to the synchronous standby which is related to the determination in step S43 may be caused by the change of the state of the server 2 due to, for example, the failover process, the fallback process or the synchronization mode switching process. In addition, the change from the synchronous standby to the asynchronous standby which is related to the determination in step S45 may be caused by the change of the state of the server 2 due to, for example, the fallback process or the synchronization mode switching process. Further, the change of the master server 2A which is related to the determination in step S47 may be caused by the change of the state of the server due to the failover process.

In addition, the notification (instruction) from the linkage controller 24 to the AP server 3 in steps S44, S46, S49, and S50 is an example of the notification of the change of the connection destination server 2 from the linkage function 60 to the AP server as indicated in the numeral (iii) of FIG. 14.

<1-4-3> Example of Operation of Connection Controller of AP Server

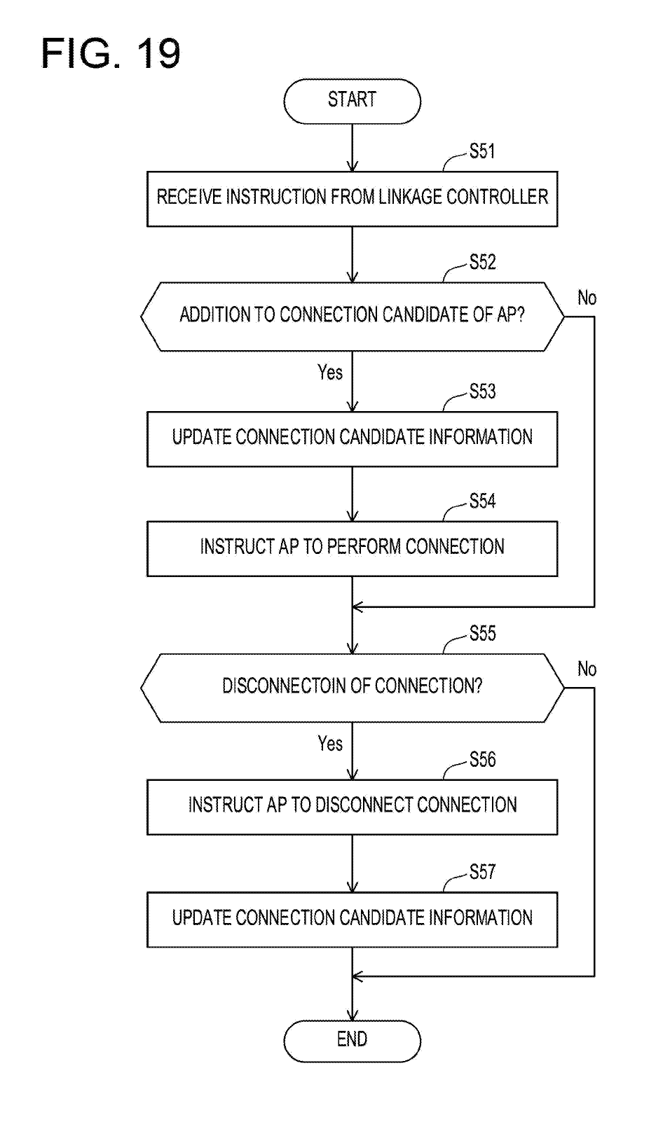

Next, an example of an operation of the connection destination switching process by the connection controller 321 of the AP server 3 will be described with reference to FIGS. 14 and 19.

As illustrated in FIG. 19, the cluster controller 32 of the AP server 3 receives an instruction from the linkage controller 24 (step S51).

The connection controller 321 determines whether the received instruction is related to an addition to the connection candidate of the AP (step S52). When it is determined that the received instruction is not related to the addition to the connection candidate of the AP (“No” in step S52), the process proceeds to step S55.

When it is determined that the received instruction is related to an addition to the connection candidate of the AP (“Yes” in step S52), the connection controller 321 updates the connection candidate information 311 to make the instructed node 2 valid for the reference task of the synchronous data (step S53). Then, the connection controller 321 instructs the AP to establish a connection with the node 2 (step S54), and the process proceeds to step S55.

When the instruction to establish the connection is received, the AP (e.g., the cluster process 30A) establishes the connection with the instructed node 2.

In step S55, the connection controller 321 determines whether the received instruction is related to the disconnection of a connection. When it is determined that the received instruction is not related to the disconnection of a connection (“No” in step S55), the process is terminated.

When it is determined that the received instruction is related to the disconnection of a connection (“Yes” in step S55), the connection controller 321 instructs the AP to disconnect the connection with the node 2 (step S56; see the numeral (iv) in FIG. 14). In addition, the connection controller 321 updates the connection candidate information 311 to make the instructed node 2 invalid for the reference task of the synchronous data (step S57), and the processing is terminated.

When the instruction to disconnect the connection is received, the AP (e.g., the cluster process 30A) disconnects the connection established with the node 2. The target of the disconnection of the connection may be all of the nodes 2 or the instructed node 2.

<1-4-4> Example of Operation of Distribution Unit of AP Server

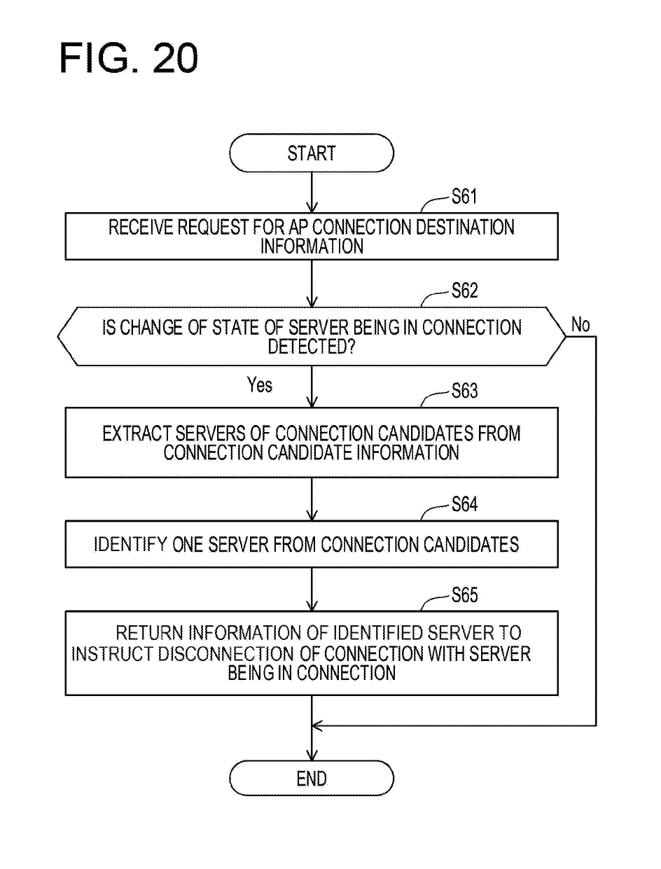

Next, an example of an operation of the connection destination distributing process by the distribution unit 322 of the AP server 3 will be described with reference to FIGS. 14 and 20.

As illustrated in FIG. 20, the cluster controller 32 of the AP server 3 receives a request for information of a connection destination of the AP from the cluster process 30A of the application operating by the AP server 3 (step S61).

The distribution unit 322 refers to the connection candidate information 311, and determines whether a change of the state of the servers 2 being connected with the AP server 3 is detected (step S62). When it is determined that a change of the state is not detected (“No” in step S62), the process is terminated. In this case, the distribution unit 322 may make a response to the effect that there is no change in the connection destination or transmit the information of the servers 2 being connected with the AP server 3.

When it is determined that a change of the state is detected (“Yes” in step S62), the distribution unit 322 refers to the connection candidate information 311 and extracts the servers 2 of the connection candidates from the connection candidate information 311 (step S63). For example, when the request for information of a connection destination requests information of the servers 2 of the connection destinations related to the reference task of the synchronous data, the servers 2 in the “synchronous standby” (and “master”) state may be extracted as the servers 2 of the connection candidates.

The distribution unit 322 identifies one of the servers 2 of the extracted connection candidates by using, for example, the load balancing technique (step S64).

Then, the distribution unit 322 returns the information of the identified server 2 (e.g., identification information or various addresses) to the AP in response, and instructs the AP to disconnect the connection with the servers 2 being connected with the AP (step S65; see the numeral (v) of FIG. 14). Then, the process is terminated.

In addition, when the update task is generated by the terminal 4 via the AP server 3 during any one of the above-described processes by the cluster controller 23, the linkage controller 24, and the cluster controller 32 or after the processes, the master server 2A may perform the following process.

For example, the DB controller 22 of the master server 2A starts the update transaction, and performs the write of the WAL to the DB 21 and the transfer (e.g., broadcasting) of the WAL to the standby server 2B. Further, when a response to the transfer is received from all of the nodes 2 set to the synchronous standby state in the node list 213 among the standby servers 2B, the DB controller 22 terminates the update transaction.

### <1-5> Example of Hardware Configuration

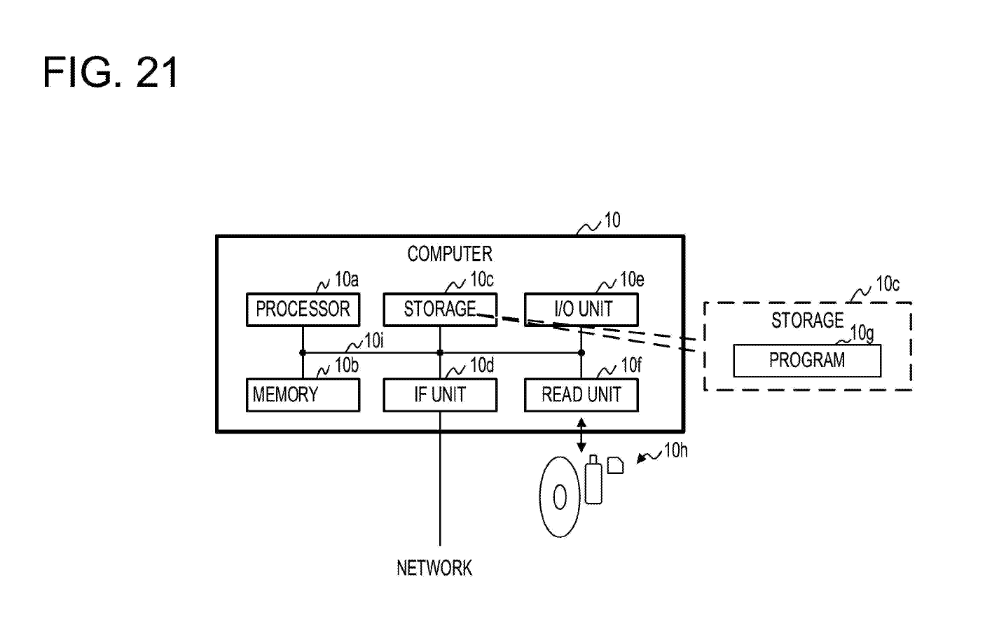

Next, an example of a hardware configuration of the nodes 2 and 3 according to an embodiment will be described with reference to FIG. 21. Since the nodes 2 and 3 may have the same hardware configuration, an example of a hardware configuration of a computer 10 which is an example of the node 2 or 3 will be described.

As illustrated in FIG. 21, the computer 10 may include, for example, a processor 10a, a memory 10b, a storage 10c, an interface (IF) unit 10d, an input/output (I/O) unit 10e, and a read unit 10f.

The processor 10a is an example of an arithmetic processor that executes various controls or arithmetic operations. The processor 10a may be connected to the respective blocks in the computer 10 to be able to communicate with the blocks via a bus 10i. As the processor 10a, for example, an integrated circuit (IC) such as a CPU, an MPU, a GPU, an APU, a DSP, an ASIC, or an FPGA may be used. In addition, the MPU stands for a micro processing unit. The GPU stands for a graphics processing unit. The APU stands for an accelerated processing unit. The DSP stands for a digital signal processor. The ASIC stands for an application specific IC, and the FPGA stands for field-programmable gate array.

The memory 10b is an example of hardware that stores information such as varies pieces of data or programs. The memory 10b may be, for example, a volatile memory such as random access memory (RAM).

The storage 10c is an example of hardware that stores information such as various pieces of data or programs. The storage 10c may be, for example, various storage devices including a magnetic disk device such as a hard disk drive (HDD), a semiconductor drive device such as a solid state drive (SSD), and a volatile memory. The volatile memory may be, for example, a flash memory, a storage class memory (SCM), or a read only memory (ROM).

In addition, the DB 21 of the DB server 2 illustrated in FIG. 5 may be implemented by at least one storage area of the memory 10b and the storage 10c of the DB server 2. In addition, the memory unit 31 of the AP server 3 illustrated in FIG. 11 may be implemented by at least one storage area of the memory 10b and the storage 10c of the AP server 3.

In addition, the storage 10c may store a program 10g for implementing all or some of the various functions of the computer 10. The processor 10a deploys the program 10g stored in the storage 10c, in the memory 10b, and executes the program 10g, so as to implement the functions of the DB server 2 illustrated in FIG. 5 or the AP server 3 illustrated in FIG. 11.

For example, in the DB server 2, the processor 10a of the DB server 2 deploys the program (connection control program) 10g stored in the storage 10c, in the memory 10b, and executes an arithmetic processing, so as to implement the functions of the DB server 2 according to the synchronization mode. The corresponding functions may include the functions of the cluster controller 23 and the linkage controller 24.

In addition, in the AP server 3, the processor 10a of the AP server 3 deploys the program (connection control program) 10g stored in the storage 10c, in the memory 10b, and executes an arithmetic processing, so as to implement the functions of the AP server 3. The corresponding functions may include the functions of the cluster controller 32 (the linkage controller 321 and the distribution unit 322) and the linkage controller 33.

In addition, the program 10g which is an example of the connection control program may be distributed and installed in the DB server 2 illustrated in FIG. 5 and the AP server 3 illustrated in FIG. 11 according to the functions to be implemented by the corresponding program 10g.

The IF unit 10d is an example of a communication interface that performs, for example, a connection and a communication with the network 1a, 1b, or 5. For example, the IF unit 10d may include an adaptor that complies with, for example, the LAN or an optical communication (e.g., fiber channel (FC)).

For example, the program 10g of the DB server 2 may be downloaded from the network 5 to the computer 10 via the corresponding communication interface and the network 1b (or a management network), and stored in the storage 10c. In addition, for example, the program 10g of the AP server 3 may be downloaded from the network 5 to the computer 10 via the corresponding communication interface, and stored in the storage 10c.

The I/O unit 10e may include any one or both an input unit including, for example, a mouse, a keyboard or an operation button and an output unit including, for example, a monitor such as a touch panel display or a liquid crystal display (LCD), a projector or a printer.

The read unit 10f is an example of a reader that reads information of data or a program written to a write medium 10h. The read unit 10f may include a connection terminal or device that allows the write medium 10h to be connected thereto or inserted thereinto. The read unit 10f may be, for example, an adaptor that complies with, for example, a universal serial bus (USB), a drive device that performs an access to a write disk, or a card reader that performs an access to a flash memory such as an SD card. In addition, the program 10g may be stored in the write medium 10h, and the read unit 10f may read the program 10g from the write medium 10h and store the read program 10g in the storage 10c.

The write medium 10h may be, for example, a non-transitory write medium such as a magnetic/optical disk or a flash memory. The magnetic/optical disk may be, for example, a flexible disk, a compact disk (CD), a digital versatile disc (DVD), a blue ray disk or a holographic versatile disc (HVD). The flash memory may be, for example, a USB memory or an SD card. In addition, the CD may be, for example, a CD-ROM, a CD-R or a CD-RW. In addition, the DVD may be, for example, a DVD-ROM, a DVD-RAM, a DVD-R, a DVD-RW, a DVD+R, or a DVD+RW.

The above-described hardware configuration of the computer 10 is merely exemplary. Accordingly, increase/decrease of hardware (e.g., addition or deletion of an arbitrary block), division of hardware, integration of hardware into an arbitrary combination, or addition or deletion of a bus in the computer 10 may be appropriately performed.

### <2> Miscellaneous

The technology according to the above-described embodiment may be modified/altered and executed as follows.

For example, the function of at least one of the DB controller 22, the cluster controller 23, and the linkage controller 24 illustrated in FIG. 5 may be combined or divided. Further, the function of at least one of the cluster controller 32 and the linkage controller 33 illustrated in FIG. 11 may be combined or divided.

In addition, the processor 10a of the computer 10 illustrated in FIG. 21 is not limited to a single processor or a single core processor, and may be a multi-processor or a multi-core processor.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
identifying, upon detecting a change of a state of one or more servers included in a server group, a server in a synchronous standby state with respect to a primary server after the detection of the change from servers included in the server group after the detection of the change; and
requesting, upon receiving an access request from a terminal, the terminal to connect to the identified server.

2. The non-transitory computer-readable recording medium according to claim 1, wherein
the change of the state of the server is related to at least one of a failover, a fallback, or a synchronous state of a server.

3. The non-transitory computer-readable recording medium according to claim 1, the process further comprising:
identifying, upon detecting a first change of a state of a server to which the terminal is connecting, a server in a synchronous standby state with respect to a primary server after the detection of the first change; and
requesting the terminal to connect to the identified server.

4. The non-transitory computer-readable recording medium according to claim 1, the process further comprising:
requesting, upon detecting the change, the terminal to disconnect from the servers included in the server group.

5. The non-transitory computer-readable recording medium according to claim 1, the process further comprising:
requesting, upon detecting a first change of a state of a server to which the terminal is connecting, the terminal to disconnect from the servers included in the server group.

6. The non-transitory computer-readable recording medium according to claim 1, wherein
the change includes a change of a server which becomes a synchronous standby state with respect to the primary server due to a change of a log transfer time.

7. A connection control method, comprising:
identifying by a computer, upon detecting a change of a state of one or more servers included in a server group, a server in a synchronous standby state with respect to a primary server after the detection of the change from servers included in the server group after the detection of the change; and
requesting, upon receiving an access request from a terminal, the terminal to connect to the identified server.

8. The connection control method according to claim 7, wherein
the change of the state of the server is related to at least one of a failover, a fallback, or a synchronous state of a server.

9. The connection control method according to claim 7, further comprising:
identifying, upon detecting a first change of a state of a server to which the terminal is connecting, a server in a synchronous standby state with respect to a primary server after the detection of the first change; and
requesting the terminal to connect to the identified server.

10. The connection control method according to claim 7, further comprising:
requesting, upon detecting the change, the terminal to disconnect from the servers included in the server group.

11. The connection control method according to claim 7, further comprising:
requesting, upon detecting a first change of a state of a server to which the terminal is connecting, the terminal to disconnect from the servers included in the server group.

12. The connection control method according to claim 7, wherein
the change includes a change of a server which becomes a synchronous standby state with respect to the primary server due to a change of a log transfer time.

13. A connection control apparatus, comprising:
a memory; and
a processor coupled to the memory and the processor configured to:
identify, upon detecting a change of a state of one or more servers included in a server group, a server in a synchronous standby state with respect to a primary server after the detection of the change from servers included in the server group after the detection of the change; and
request, upon receiving an access request from a terminal, the terminal to connect to the identified server.

14. The connection control apparatus according to claim 13, wherein
the change of the state of the server is related to at least one of a failover, a fallback, or a synchronous state of a server.

15. The connection control apparatus according to claim 13, wherein
the processor is further configured to:
identify, upon detecting a first change of a state of a server to which the terminal is connecting, a server in a synchronous standby state with respect to a primary server after the detection of the first change; and
request the terminal to connect to the identified server.

16. The connection control apparatus according to claim 13, wherein
the processor is further configured to:
request, upon detecting the change, the terminal to disconnect from the servers included in the server group.

17. The connection control apparatus according to claim 13, wherein
the processor is further configured to:
request, upon detecting a first change of a state of a server to which the terminal is connecting, the terminal to disconnect from the servers included in the server group.

18. The connection control apparatus according to claim 13, wherein
the change includes a change of a server which becomes a synchronous standby state with respect to the primary server due to a change of a log transfer time.
